(19) United States
(12) Patent Application Publication
(10) Pub. No.: US 2013/0198027 A1
(43) Pub. Date: Aug. 1, 2013

(54) INTELLIGENT INFORMATION LIFE MANAGEMENT SYSTEM FOR CONSUMERS

(71) Applicants: Robert B. Anthonyson, Sunapee, NH (US); Leonard Schrank, Brussels (BE); Joseph P. Mullaney, Medfield, MA (US)

(72) Inventors: Robert B. Anthonyson, Sunapee, NH (US); Leonard Schrank, Brussels (BE); Joseph P. Mullaney, Medfield, MA (US)

(21) Appl. No.: 13/803,413

(22) Filed: Mar. 14, 2013

Related U.S. Application Data
(63) Continuation-in-part of application No. 13/363,841, filed on Feb. 1, 2012.

(51) Int. Cl. G06Q 10/00

(52) U.S. Cl. CPC G06Q 10/20
USPC 705/26.4; 705/305; 705/28

(57) ABSTRACT

The invention generally relates to consumer product lifecycle maintenance and systems and methods therefor. The invention generally involves receiving and storing a consumer registration of a tangible asset, matching a provider to the consumer based on a later-arising maintenance need associated with the asset and/or follow-on items related to the asset such as accessories, consumables, direct replacements and similar items, and relaying a communication from the provider to the consumer.

### CROSS-REFERENCE TO RELATED APPLICATIONS

This application is a continuation-in-part of U.S. patent application Ser. No. 13/363,841, filed Feb. 1, 2012, the contents of which are hereby incorporated by reference in their entirety.

### FIELD OF THE INVENTION

The invention generally relates to an intelligent information life management system for consumers and systems and methods therefor.

### BACKGROUND

Most consumers have a vast number of things to remember to do in their busy daily lives and use a variety of methods that serve as reminders to get those things done. These reminders can be in the form of paper based “to do” lists, electronic spreadsheets, reminders from e-mail systems, yellow stickies, paper files and a variety of other disparate methodologies. Many of the things that consumers need to remember to get done relate to “big-ticket” items like cars, houses, systems within houses, lawnmowers, appliances, furnaces and other goods that regularly require consumer servicing attention. Typically, these items are associated with ongoing maintenance requirements. Missing a maintenance task can create unsafe conditions that cause the destruction of the item and/or even risk the safety of people. In addition, consumers can easily forget their preferred vendor for assets that need infrequent servicing or replacement.

Further, as technology changes, some items become obsolete, or are joined in the market place by more efficient, more attractive alternatives. If an owner is unaware that a safer, more efficient, more functional product is available, they could lose significant money or expose themselves to danger by continuing to rely on their existing possessions.

Product providers such as manufacturers and stores, as well as service providers, seek to keep people abreast of their maintenance events in a variety of ways. Cars, for example, frequently have an owner's manual in a glove compartment, in which is printed a service interval schedule. Furnace repairmen will sometimes clip a cardboard tag to a furnace on which they may hand-write a next service date. However, some products, such as home computers or insulation, appear to be sold with the expectation that a customer will discover on their own when a safer, more up-to-date, or more efficient version is available.

When a consumer sees from their car owner's manual, furnace service tag, or news articles about new technology that it is time for service or replacement, they are left to their own information-gathering abilities. In our so-called information age, this can leave a person feeling overwhelmed. So many web sites, advertisements, and spam emails clamor for our attention, that it can be nearly impossible to filter through the deluge and figure out who the most reputable furnace guy is, or what kind of wall paint is safe around our children, or which of our cars needs an oil change next and whether it's the one that requires synthetic motor oil.

### SUMMARY

The invention provides systems, methods, and devices for managing a lifecycle of a possession. Using systems and methods of the invention, a consumer may register his or her assets, or allow others to register them on his or her behalf, for a variety of useful purposes, including:
1) maintaining each asset over its useful life by registering the product and receiving timely communication relevant to the product, particularly communication that is relevant to the consumer's needs at a time future from obtaining the product;
2) sharing the asset information with vendors while protecting the identity of the consumer so that targeted offers for service or asset replacement can be made directly between the vendor and the consumer;
3) broadcasting information about a scheduled service event associated with an asset to a number of vendors and/or service providers and receiving competing bids to perform the scheduled service;
4) broadcasting information about consumables and/or accessories associated with an asset to a number of vendors and receiving competing bids;
5) transferring registration records of assets, whole inventories, or categories of assets from owner to owner, including service histories and information about suitable vendors so that when an asset such as a building or vehicle is sold, the buyer has a valuable tool for managing the lifecycle of the asset; and
6) Retaining documentation related to the asset such as installation manuals, user manuals, parts and accessories information, care and use instructions, designer or creator's notes, sales materials, detailed descriptions, appraisals, etc.

In that this invention allows consumers to provide detailed information regarding their most cherished and/or expensive possessions, one of the critical attributes of certain embodiments of this invention is that consumers retain their anonymity within the system. Profile information may be provided at the complete discretion of the consumer to make offers highly relevant but would be limited to information such as ZIP code.

The invention includes the insight that not only can a vendor and a consumer be matched based on a future event, but that future events may reflect service needs of a consumer and also that these events represent opportunities for vendors to bid competitively to perform the service. By providing a database in which a consumer can register their possessions and create an inventory thereof, systems of the invention can identify at what time a notice should be broadcast to vendors inviting the vendors to submit bids, ads, or offers that may interest a consumer.

A consumer can register each of one or more possessions at any level of detail, from general category to specific item, along with a start date reflecting the date the possession was obtained, manufactured, purchased, put into use, or last serviced. Systems of the invention can apply rules, which can be derived according to the identity of the possession, manufacturer specifications, expert recommendations, or consumer preference, to identify an event date for which a vendor/provider should be notified of some relevant information. By applying rules to facts in this way, the system can deliver communications to providers (vendors) that allow the providers to submit timely bids or offers. These communications can include information with any level of specificity or generality according to system parameters. For example, a vendor can be told that one particular anonymous consumer needs a certain type of service for a certain model of asset, or a report can be prepared for vendors that summarizes a number of consumers with certain categories of possessions in certain geographical areas.

In a preferred embodiment, a consumer lists their tangible assets. By listing an asset or possession, a consumer may be identified as a target for special offers by providers. Through this approach, a consumer's assets or possessions indicate prospective buying interests.

Particularly where big-ticket assets, such as buildings or vehicles are involved, the invention provides a tool to enhance the value of the asset by making available to a prospective subsequent owner a registration record that can include a detailed service history, specifications, or a future service schedule. The registration can be transferred to a subsequent owner of a possession. Transfers can be given effect in any number of ways including a cooperative, in-system transaction between a seller and a buyer, a search-and-copy by a buyer, or a statistical prediction model by a computer device of the system to create a new registration for a buyer.

The invention further provides consumer anonymity, consumer-controlled parameters limiting incoming communication, provider criteria satisfaction, commercial scaling, and complementary information linkage, as described herein. Consumers may keep any combination of their information anonymous or private allowing, for example, only demographic aggregation of their information or blind or double-blind communication with providers. Regardless of privacy settings, providers may establish criteria and initiate communication where their criteria are satisfied. Operations of the invention, such as communication and its content, can relate to an aggregate number of consumers, products, or combinations thereof, thereby achieving economies of scale, for example, if a provider wants to send a communication only if at least 1,000 possessors of a given product or category of product are registered. The invention allows complementary information to be linked even if two different providers supply information. Examples and illustrations of the foregoing capabilities of the invention will be discussed below.

In certain aspects, the invention provides a method for managing a lifecycle of a possession. The method includes receiving, by a computer, a registration including information containing the identity of a consumer and a possession of the consumer, storing the registration in a database, identifying a future service event date associated with the possession, and sending a notification to a provider that a consumer has a possession with a future event date. The notification may be sent to a plurality of providers, such as a group of providers that match criteria established by the consumer. Where, for example, the criteria is a geographical location for a candidate provider, the method can be used to solicit bids from providers (e.g., merchants) that are close to the consumer. The providers can make an offer to provide a service associated with the possession and the event date and have this offer relayed to the consumer.

Techniques can be employed to encourage participation or to encourage competitive bidding. For example, certain providers can be allowed to see information about other offers, other providers, or other inside information. In certain embodiments, providers that are registered participants in the system can see information about other offers, such as the best outstanding offer. This encourages providers to participate and make competitive offers. This could also encourage providers to make multiple offers regarding all of a consumer's assets or to partner with other vendors to make multi-vendor offers.

Once bids are submitted (offers are made) the consumer can select one. In certain embodiments, consumers make selections extrinsically, or outside of the computer system. That is, the providers submit offers, which the consumer can view, and then the consumer acts independently to approach the selected provider. However, in some embodiments, the consumer selects an offer within the system—e.g., choosing an offer via an electronic device. The system can proceed to schedule a service date or refer the consumer or provider to a payment system or even to process payment.

Methods can include notifying providers and allowing them to make offers pertinent to service event dates that are in the future, for example, more than a year later than the offer date, or more than five years later. Providers can make offers on combinations and patterns of events. For example, a series of service events, such as every future oil change for a car (or a year's worth), can be scheduled, and the provider can send notice to a consumer that they provide the service.

Methods can include storing a plurality of registrations. The invention further provides for notifying a provider in relation to an event date associated with a registration. For example, an email can be sent to a piano tuner that a consumer has a piano due for a tuning. Further, notifying the provider(s) can include information about the characteristics of an aggregate group of people who each have a registration for a possession of a certain category. For example, the notice to providers can recite that 1,000 males aged 18 to 24 have upcoming college graduations, or that 150 different people who each own a 1999-2003 Volkswagen Jetta are included in the event group. Notice can include nested sets of information. For example, notice can be sent to a seller of heating oil that between 100 and 500 houses with oil tanks are registered within a certain 1 mile radius; between 500 and 5,000 within a ten mile radius, and between 5,000 and 15,000 within a fifteen mile radius. This way, a price can be quoted to the provider for the notification service, and the provider can choose which subset of registrants it wishes to transmit communication to.

In certain aspects, the invention provides a computer-based system for managing a lifecycle of a possession that includes a processor configured to execute code stored in a tangible, non-transitory memory. The system can receive a registration that includes information containing the identity of a consumer and a possession of the consumer, store the registration in a database in the memory, identify a future service event date associated with the possession, and send a notification to a provider with information about the service event date. The system can further be configured to perform any steps herein such as notifying a plurality of providers.

The possession can be any asset including, for example, a toy, an appliance, a contract, a car, or a painting. In certain embodiments, the possession is a tangible, “big ticket” asset such as a building, a vehicle, a real estate property, and a fixture.

In certain aspects, the invention provides a tangible, non-transitory computer readable medium containing programming instructions to facilitate managing a lifecycle of a possession by, when executed by a computer, causing the computer to receive a registration including information containing the identity of a consumer and a possession of the consumer, store the registration in a database, identify a future event date associated with the possession, and send a notification to a provider that a consumer has a possession with an event date.

Systems and methods of the invention can provide for sharing qualifying data about the providers with the consumer. For example, a consumer can see ratings of the providers, either gathered extrinsically and/or provided by user/participants. Consumers can qualify the providers they wish to see (e.g., “pre-qualifying merchants”) by limiting providers according to geographical location, a rating value, or a record of previous transactions.

Systems and methods of the invention can provide for preventing either of the consumer or the provider from knowing the identity of the other, for example, prior to or during any of the steps recited herein.

In certain aspects, the invention provides a method of managing a lifecycle of a possession that includes the ability to document a transfer of ownership or to provide a new owner with valuable information that enhances the value of the new possession. Methods include storing, in a tangible and non-transitory memory of a computer, an inventory of an owner. An inventory includes one or more registrations that each include information about a possession. Methods further include identifying an event date associated with the possession, receiving a notice of a transfer from the owner, and transferring the registration into an inventory of a buyer.

In certain aspects, the invention provides a computer-based system for managing a lifecycle of a possession including documenting a transfer or giving a new owner valuable information. Systems of the invention include a computer including a tangible, non-transitory memory coupled to a processor and configured to, by means of the processor store, in the memory, an inventory of an owner, identify an event date associated with the possession, receive a notice of a transfer from the owner, and transfer the registration into an inventory of a buyer.

Systems and methods of the invention can further provide for creating an account for the buyer and the inventory of the buyer. For example, a person planning to buy a possession that is registered may be so informed. The person may then register to participate in the system, causing an account to be created. Generally, creating an account for a participant can include creating an inventory, i.e., a digital record of registered possessions of the account-holder. A digital record of registered possessions generally includes data records herein called registrations. A registration includes data that relates to the identity of a possession, such as a serial number, a category, or a descriptive phrase provided by a consumer/user. A consumer can provide the data for the registration in any number of ways including, for example, input via the Internet that causes data to be transferred into the registration from a third-party vendor. A user can also directly input data or a 3^{rd} party, such as a salesperson, can input the data on the user's behalf. Systems and methods of the invention create an event date related to the registered possession. The event date can be created directly by a user, according to programmed rules (e.g., if possession category is car, then create oil change event every three months for ten years), lookup operation (e.g., if possession is furnace, then if brand is Trane, then retrieve service schedule for model from Trane server), or sent to the registration by a provider (e.g., upon invitation or permission of consumer).

Systems and methods of the invention can further provide for denying access to the registration to anyone after receiving the notice of transfer and prior to transferring the registration.

Systems and methods of the invention can further provide for notifying the owner, or a provider, of the event date or relevant information as of some time specified in relation to the event date (e.g., 1 month prior). For example, a consumer can register a car and then receive an oil change reminder every three months for years. Or, a consumer can register a new computer, and receive a reminder four years later to have any service done while the computer is still under warranty. A consumer can register a car and, ten years later, get a reminder to change the timing belt and water pump. Reminders can be sent via email, as calendar entries, as information transmitted within a program or mobile app of the system, text/SMS messages, or other.

Systems and methods of the invention can further provide for transferring registrations. For example, when a new owner buys a possession, the registration can be transferred into the new owner's inventory within the system. Thus, the new owner can receive detailed records, service history, or future events including, for example, architectural drawings, device specifications, make and model of parts, any or all scheduled event dates, identity of a builder, identity of a service-person, identity of an architect, and device serial number.

Systems and methods of the invention can be used by a purchaser of an item to enhance the value they derive from the item by giving them a valuable tool for product lifecycle management. Further, the invention can be used by a builder or a maker of an item to create a registration for a new item and transfer the registration into the inventory of a first buyer (i.e., the first owner can be the builder/maker and the second owner can be the first buyer). A registration transfer can be repeated for successive owners of the possession.

In certain aspects, the invention provides a tangible, non-transitory computer readable medium containing programming instructions to facilitate managing a lifecycle of a possession. The instructions cause the computer to store, in a database, an inventory of an owner comprising a registration, identify an event date associated with the possession, and transfer the registration into an inventory of a buyer. The instructions can further cause the computer to perform any of, or any combination of, the following steps: receive a notice of a transfer from the owner; notify, prior to the event date (e.g., less than three months prior), the owner of the event date; treat a buyer as the owner after transferring the registration; notify a buyer of a plurality of scheduled service events associated with the possession; provide a buyer with a service record of the possession including data generated prior to the transfer; obtain information from a third-party vendor in response to input from the owner and through the Internet; or store obtained information in the registration.

In certain aspects, the invention provides a system for managing a lifecycle of a possession, the system comprising a computer including a tangible, non-transitory memory coupled to a processor. The system is configured to, by means of the processor, receive a registration that includes information containing the identity of a consumer and a possession of the consumer and store it in a database. The system can identify a future event date associated with the possession and provide notice to a provider that a consumer has a possession with a future event date. Further, the system can receive and save in the memory a plurality of registrations that each have information identifying a possession and its record owner, receive parameters from a provider that define a sub-set of the registrations, and run a simulation to determine which consumers are associated with the sub-set. The system can then provide a result of the simulation to the provider. Methods include using a processor for receiving a registration from a consumer at a server over a network, receiving parameters from a provider, wherein the parameters define a sub-set of the registrations, running a simulation to determine which consumers are associated with the sub-set, and providing a result of the simulation to the provider. The invention provides methods and systems for transmitting an offer from a provider to the sub-set defined by the parameters, receive updated parameters from the provider after the result is provided to the provider, run an additional simulation, or any combination thereof. A distribution list can be generated that includes the customers associated with the subset. Such a list can include all information (i.e., name and contact information) where the customers have so permitted, or anonymous distribution lists can be provided that show demographic information about recipients or even email addresses that have been made anonymous (e.g., a unique code for a handle using the system administrator's domain name (e.g., JFI34324JX “@” system dot com) such that, when an email is sent to the address, it is received at a server and re-sent to the user's personal email address).

The invention further provides systems and methods for creating a catalog. A custom catalog can be created for an individual consumer. For example, a computer system can receive numerous electronic communications from various providers, and can compose contents from those communications into a display or file that is provided for the consumer. A catalog can be composed by referencing metadata in the communication from the providers such as, for example, markup language tags (e.g., XML) that indicate components of the communication (e.g., title, main picture, additional picture, description, vendor name, vendor URL, price). In certain embodiments, a catalog is composed by giving providers “shells”, or digital forms, into which the vendors contribute data. In certain embodiments, the invention provides a digital app tool that a consumer uses on their computing device to “tag” web pages, pictures, or descriptions of items of interest. Information can be received from third-party providers regarding tagged items, and a catalog is prepared. Further, a catalog can be generated based on purchase behavior of a consumer (e.g., where a system administrator has a relationship with an independent online vendor, a consumer's shopping at the independent vendor's website can provide information that is used in assembling a catalog).

Where systems and methods of the invention transmit an offer from a provider to a consumer, the offer can be further transmitted in the context of a catalog (e.g., as one of many offers, or with a “you may also be interested in . . . ” page).

In certain aspects, the invention provides a method for relaying a matched offer that includes receiving, from a consumer, a registration including information about a possession. In certain embodiments, the invention provides a database wherein a consumer may inventory their possessions. For example, a consumer may create a registration (i.e., a digital file or record) for each of one or more items they possess. The consumer may enter a word (e.g., “car”, “laptop”), which is then included in the database record denoting the consumer has registered the corresponding item. The invention can receive and record information in much greater detail. For example, a consumer may put in any of make, model, cost, or year of their possession, or browse or be automatically linked to a commercial web site describing their item, retrieve information from that website or cause it to be retrieved or saved into their registration. By these and related means, a consumer may register any possessions that they want to register into the database.

The database then enables communications to be provided to the consumer that include content specific to a registered possession. In particular, a communication may include content that is specific to a possession and a specific event date. For example, registering a new car can cause a series of event dates with a three month frequency, each event date being identified as an oil change. Then, at or some amount of time prior to that date, a communication can be transmitted to the consumer including a reminder to change their oil in that car. While other examples will be given in more detail below, an event need not be recurring, nor defined by a start date. For example, if a consumer registers a painting by a famous painter as a possession, a communication can be transmitted—even ten years in the future—notifying the consumer of an upcoming art auction and the deadline for entering lots. Alternatively, if a consumer registers, say, a swimming pool, then every autumn a communication can be transmitted that reminds the consumer to winterize the pool.

The information provided or obtained by the consumer is stored in the database. In some embodiments, the consumer has a profile stored in the database, which can optionally include information about the person, methods of payment, social or professional connection information, or other preference information. Generally, each registered possession will have a corresponding registration, which can be linked to the consumer's profile. A registration will generally include at least information about the possession, for example, a word, a serial number, a date on which the product was manufactured, obtained, or put into use, a scheduled maintenance date, or other information.

Systems of the invention can operate subject to a criterion being satisfied. In some embodiments, a party (e.g., a provider) will have a criterion and data in the database can satisfy or not satisfy the criterion. Subject to the data satisfying the criterion, communication transmitted to a consumer can optionally include certain content. Whether data satisfy a criterion can be tested within a device of the invention, or data can be proffered to a party and the party can determine whether the data satisfy their criterion. Where data provided by a user satisfies a criterion from a provider, a communication from the provider is relayed to the consumer.

A general feature of the invention is the provision of a service whereby a consumer may register a possession to receive a number of relevant updates, offers, or reminders specific to the possession or the consumer's needs. To illustrate, a consumer may purchase a car and register the car in the database including, for example, putting in an odometer reading or model year. At a relevant point thereafter, when the car is due for a service such as a new timing belt, the consumer can receive a communication saying as much. Additionally, at least in this illustrative example, a communication from a service provider can be relayed to the consumer. The relayed communication can include the information that the provider offers to change a timing belt for a certain price or is located at a certain place. In this fashion, the consumer receives helpful information prior to their need and can act on it.

Furthermore, whether the communication is relayed can be subject to conditions from the consumer, the provider, or both. A consumer may establish (through, for example, data in their profile) that they only want to receive communications from providers within a certain ZIP code, or that have at least a certain average rating as recorded with an outside institution (e.g., Yelp!, Better Business Bureau). The provider can cause their communication to be relayed only to consumers with certain attributes like follow-through frequencies or credit ratings.

The information in the database can be anonymous in that, for example, the identity of the consumer can be kept from the provider. The system can offer the consumer control over the access to or sharing of their data. For example, a consumer can, for different categories of data or different aspects of providers, define different permission levels. A consumer may generally set their personally identifying information to be private, but allow, for example, the manufacturer of their automobile or the Consumer Product Safety Commission to be able to access their telephone number. Alternatively, the consumer may allow no party access to any information, but may establish conditions under which systems of the invention operate as a relay.

In certain embodiments, a registration includes a start date. A start date can include a date that a consumer purchased an item, a date that an item was manufactured, a date that an item was put into use, or a date that represents a start, for example, of a measure of time. A start date can be arbitrarily set by the consumer or it can be set by other means. For example, a consumer can register a possession by serial number and information about a start date can be accessed from an outside source such as from the manufacturer based on that serial number. The invention generally provides for maintaining a product over time and a start date can provide a reference point for an event date. An event or a category of event can be associated with an interval or frequency such that a first event is scheduled automatically for one interval after the start date.

Intervals and frequencies can be provided by the identity of the possession. In a first simplified example, possessions that are registered in a category of “new automobile” can have a purchase date or registration date provide a start date and be associated with an oil change interval such that one interval after the start date an event is scheduled including an oil change.

Event generally refers to one or a series of functions or activities. To schedule an event generally means to create a record using a device of the invention in which the record contains information about the event and a date or time. A scheduled event is generally such a record and preferably contains data identifying a possession and optionally a consumer as well as one or more functions or activities and a date or time. In certain embodiments, a scheduled event is a record in a database.

With these functions described, it will be appreciated that the invention provides methods in which a plurality of registrations are stored in the database. For a given consumer, a plurality of registrations can represent at least a partial inventory of their possessions. Methods further includes storing registrations for a plurality of consumers. The invention thus offers methods that operate with a plurality of consumers. For example, a provider can have as a criterion that a certain number (e.g., 10, 100, 1,000, millions, or multi-millions) of consumers have a certain product or category of product registered. A provider may have as a first criterion that at least one consumer has a certain product registered and, responsive to that criterion being satisfied, information from the provider may be included in a communication that is transmitted or relayed to the consumer. That information could include, for example, an offer by the provider to sell a certain good or service for a certain price. The provider could further include criteria directed to one or more threshold numbers of registrants which, if met, causes the transmitted communication to include a corresponding price. In this way, a provider can offer a service to one consumer at a first price, but can offer a lower price if a higher number of consumers list a certain product or category of product in the database or if a corresponding number of consumers agree to purchase the service.

A scheduled event generally includes information about an event. An event can include servicing a possession (e.g., oil change), replacing a possession, or replacing a part of a possession. An event could include an informational imperative (“see if a better version is available”) or a conditional activity (“if DJIA<12,000 then sell the gold”).

Scheduling an event can involve rules. Rules, generally, are customizable conditional constructs by which methods of the invention can operate. Systems and methods of the invention can provide “general” rules, which may be described as blanks or templates. Consumers can define a rule through their own input or through the modification of a provided rule. Alternatively, a consumer may accept or use a provided rule as-is. As one example, a consumer may define a rule whereby a possession is a house and the registration record identifies the house and identifies lease information. The lease information includes a tenant move-out date. Upon arrival of any move-out date, the consumer's rule operates to schedule an event including a reminder to the consumer to order a cleaning service. Another example of a rule is alluded to above in the form of a regular interval of oil changes associated with a start date for an automobile. This could provide a template or a default rule that systems of the invention offer or implement as-is or with modifications by a user consumer.

The invention generally provides for a communication to be received by a consumer at a determined time prior to a scheduled event. The communication can include, optionally subject to the satisfaction of conditions or criterion, information from a provider. The information from a provider can be an offer, factual information, or any other information (e.g., entertainment content, instructions, a recall, a warning, a class-action announcement).

In certain embodiments, complementary information is added to the communication—that is, information that is complementary to the information relayed on behalf of the provider. The complementary information can come from any source, including another provider. The communication can include simply more or additional information (e.g., subject to the same conditions and criteria as inclusion of the provider's information is subject to). However, by further limiting it to the category of complementary information, the value of the communication to the consumer is enhanced. For example, an automobile dealer that has been providing oil change reminders may have its reminder for the tenth oil change complemented by an offer from a tire provider for a new set of tires.

Complementary information generally includes information that supplements other information without being redundant. In some embodiments, methods of the invention include relaying an offer in the communication and optionally identifying a complementary offer relating to the communication, and wherein relaying the communication includes relaying the offer and the complementary offer.

In certain aspects, the invention provides an apparatus for simplifying product maintenance. The apparatus generally includes a computer, i.e., a machine with a memory coupled to a processor in which the processor is configured to execute computer program instructions causing the processor to perform or cause to be performed steps of the invention.

The memory can have stored therein a database including a registration containing information identifying a product as provided by a consumer. The database can further include multiple registrations from a consumer (i.e., that person's inventory) or registrations or inventories from multiple consumers. The processor can schedule an event date based on a rule relating an event to the product or transmit a communication to the consumer at a transmit time prior to the event date by a specific amount of time.

The apparatus can transmit the communication automatically in response to the transmit time matching a time indicated by an electronic calendar. For example, a computer apparatus may have a timekeeping device within it, or it may access the present time via an information connection. By comparing the present time to a scheduled event time, the apparatus can transmit the communication at an intended time. The processor can be configured to transmit the communication with the provider information included only if data in the registration satisfies a criterion of the provider and else transmit the communication without the provider information included.

In certain aspects, the invention provides systems for consumer product lifecycle maintenance including a server apparatus for storing therein registrations or inventories. The system can also include one or more of an electronic device to be used by a consumer, the device generally having a memory, a processor, and input/output features. In certain embodiments, the server processor or the device processor can execute instructions to cause a display to appear to a consumer. The display can include an interface whereby a consumer puts data into the system or receives information from the system. In some embodiments, the display functions to provide the consumer a reminder. The reminder can notify the consumer of when a product needs attention.

Generally, a consumer may register a product by accessing software or a database on a server. In some embodiments, the consumer downloads a program or application to use to interface with the system. Alternatively, the consumer may interact with the server via a web page. In certain embodiments, the invention provides the consumer with functionality via a combination of server-side applications, use of existing consumer device applications or existing consumer web applications (e.g., Outlook calendar, Google calendar), provision of executables or applications for installation by the consumer, provision of apps to operate on a consumer device, or accessing the functionality of external content or programs (e.g., retrieve product data from website or database). For example, in certain embodiments, a consumer uses a camera to take a digital photo of a product, barcode, or QR code associated with a product. Information from the photo is interpreted into data identifying the product. For example, other product registrations within the database can first be queried for a matching code resulting in information being copied from that registration into a nascent registration for the consumer. As a back-up, systems of the invention can search the web for information associated with a matching code, resulting in copying information from the web to the nascent registration or displaying a prospectively matching web page to the consumer so that they may affirm that it represents the product they are intending to register. The consumer verifies that the system has proffered information that identifies the product they intend to register and that information is used in the consumer's nascent registration. The consumer provides any other information for the registration and the registration is included in the database. (Note that the product information, having been retrieved through a code such as a barcode or QR code and optionally verified by the consumer can then also be stored in the database independently of the consumer's registration or used for future registrations by other consumers.)

The foregoing illustrates one exemplary way by which the server processor or the device processor saves in memory an inventory file containing one or more registrations responsive to one or more inputs from the consumer. Registrations can contain information input directly by the consumer (e.g., typed in), input via the consumer (e.g., retrieved from web by consumer's efforts), input responsive to the consumer (retrieved from web based on consumer initiated activity), automatically input (copying information from other registration, from consumer's profile, or other), or any other mode. To accomplish these means, the processor can retrieve function information from an outside source. For example, a consumer registers a Smith brand furnace, and the processor retrieves from an outside source the information that a Smith brand furnace requires a new filter every three years, the filter having part number XQ99. A registration record according to the invention can contain any data pertaining to a product or possession, a consumer, a relationship between a consumer and a possession, or any other data useful for purposes of the invention. Exemplary data that may be contained within a registration may include: a name of the product; an owner of the product; a location of the product; information about the product obtained from a source other than the consumer; a color; a start date; cost; a consumer comment; a consumer review of a product; a consumer review of a provider; a universal resource locater; a digital photo; a scheduled event; a date or time; information provided by a provider (e.g., an offer or message not yet relayed to a consumer or a copy of an offer or message that has been relayed to a consumer); a coupon (e.g., digital image or code); data about a rewards or participation program; or any other data or information. The apparatus can also relay functional information retrieved from a source other than the consumer to the consumer (e.g., type of filter the furnace uses, a recall of a baby seat, preferred motor oil for a car).

Generally, systems of the invention can invoke a display, which can be visible to a consumer. Exemplary displays include a web page, a screen on a device showing an app, information displayed within a program (e.g., Outlook calendar, email, or task list), but display includes information presented for a consumer including receipt of a fax or piece of mail, for example. An interface or display of the invention can remind a consumer when a product is scheduled for attention.

Exemplary infrastructure according to systems of the invention can be used to provide a consumer with communication including communication from a provider. Accordingly, a server apparatus of the invention can include a processor that executes instructions that cause a display for a consumer that includes a reminder or content from a provider. Content from a provider can be an offer or information about a new product. The server apparatus, through functioning of the database, memory, processor, or other means, can operate within boundaries established by a consumer to limit the flow of information. For example, a consumer can use the apparatus to establish boundaries to limit the content of the communication that the consumer receives. A consumer may, for example, exclude certain or uncertain providers from contributing to a communication. A consumer may exclude certain providers by choosing them or by establishing categorical rules that result in the exclusion of certain providers (“not outside of this ZIP code”). A consumer may exclude uncertain providers by establishing limits on who is included, which limits are interpreted at a later time. For example, a consumer may establish a limit of a number of providers that may include data (“two” or “fifty”). When a communication is to be sent, the established number is not exceeded, and if a greater number of providers vie for inclusion, some of them will be excluded. The choice can be random or pseudo-random, thereby excluding uncertain providers. Or the choice performed by the apparatus can be based on application of a rule to information about the providers (e.g., “only the most frequent participants in the system).

Generally, the apparatus is configured to store in a database in the memory a plurality of inventories associated with a plurality of people, each inventory containing one or more registrations, each registration including information identifying a product. The processor can then aggregate registrations containing similar information and, responsive to a determined number of such registrations being identified, provide anonymous data to a provider about a number of people who have registered a product. The apparatus can be configured to allow a consumer to update a registration by providing additional facts about a product and saving the updated registration. In some cases, the apparatus can also be automatically updated by the asset. For example, a car may be able to transmit its mileage via Bluetooth, a USB port or some other technology. The apparatus can then schedule an additional event date based on the additional facts.

Information to identify a product can be obtained by scanning, by the consumer, of a barcode; browsing, by the consumer, to a web page that includes information about the product; and typing, by the consumer, the information identifying the product. Products and possessions according to the invention encompass a variety of tangible and intangibles, including cars, houses, constructions such as walls, roofs, swimming pools, garages, sheds, and installed components such as plumbing or insulation. Products can be electronics or appliances such as computers, power tools, dishwashers, or hot water heaters. The invention further encompasses intangibles or possessions generally shown by registration or title such as bank accounts, brokerage accounts, securities, timber, contracts, wills, insurance policies, and fictional constructs such as property held within a computer game or obligations. Further examples of possessions include novelties and general interest properties such as toys, games, club memberships, pets, digital content, tools, apparel, gardens, or web site accounts.

The invention can support rewards or participation programs through the use of point systems or participation tracking. The invention can acknowledge or operate based on institutional affiliation, such as by providing certain communication based on consumer group membership.

### BRIEF DESCRIPTION OF THE DRAWINGS

FIG. 1 shows a consumer home screen that has been composed and sent to a display according to systems and methods of the invention.

FIG. 2 shows a communication that has been relayed to a consumer including offers.

FIG. 3 illustrates a communication that has been relayed to a consumer.

FIG. 4 shows an inventory including a list of registrations that has been composed and sent to a display.

FIG. 5 shows a catalog that has been generated and sent to a display.

FIG. 6 shows portions of a registration that have been composed and sent to a display according to certain embodiments of the invention.

FIG. 7 illustrates a screen display that can be provided for transferring a registration to the inventory of a new owner.

FIG. 8 shows an inventory including a list of registrations that has been composed and sent to a display.

FIG. 9 shows portions of a registration for a property that have been composed and sent to a display according to certain embodiments of the invention.

FIG. 10 shows a provider or merchant home screen that has been composed and sent to a display according to systems and methods of the invention.

FIG. 11 shows a display resulting from sending a notification to a merchant/provider.

FIG. 12 shows a screen allowing a merchant to prepare a distribution list.

FIG. 13 shows a screen for receiving a communication from a merchant to be relayed to a consumer.

FIG. 14 is a diagram of methods according to certain embodiments of the invention.

FIG. 15 is a diagram of components of a system according to certain embodiments of the invention.

### DETAILED DESCRIPTION

Embodiments of the invention provide techniques for managing products over time. Systems of the invention enable the creation of a lifecycle for a product. A lifecycle generally defines an event or series of events, which can enable a consumer to realize a potential benefit in terms of having, maintaining, servicing, supplementing, or replacing a product. A lifecycle can be represented as a series of scheduled events, for example, as stored in a database of an inventory management device in association with information about a particular product that a consumer possesses. A consumer can provide information about a possession by registering their possession of a product in the database, thereby creating a registration. A plurality of these registrations for a consumer can then represent a consumer inventory—a record of one or more products possessed by a consumer.

In general, scheduled event, inventory, registration, a lifecycle, information, and communication refer to digital data, for example, capable of being stored on a computer readable medium. Generally, a product is something that is or has been available in a marketplace to a consumer and a possession is something that a consumer has. Typically, possessions will be products, however, the invention encompasses the registration of some possessions that were not typically products (found items, newborn kittens, medical records, passwords, bedroom paint color) as well as some products that do not strictly become possessions (a star name paid for through the international star registry, shares in a fund held in a brokerage account). A consumer may register a possession through systems of the invention, referred to for convenience as an inventory manager, invoking the creation of a lifecycle (one or more scheduled events) associated with the possession. (Possession and product are generally used interchangeably, except where context prohibits it or indicates otherwise). The system can also be used simply as a repository to store useful information for future easy access and transferability. For example, if the database contained information describing the paint colors for the outside of a home and for each interior room by brand and color code, it would make it much easier for successors to paint. The same would hold true for each and every aspect of the home including plumbing, electrical, heating, air conditioning, roof, house drawings, etc.

Consumers provide information about products to create or contribute to a registration. A registration can contain information input directly by the consumer (e.g., typed in), input via the consumer (e.g., retrieved from web by consumer's efforts), input responsive to the consumer (retrieved from web based on consumer initiated activity), automatically input (copying information from other registration, from consumer's profile, or other), or any other mode. In certain embodiments, a consumer will scan, for example, with a digital camera, a code such as a bar code, UPC code, or QR code, on or associated with a product, and systems of the invention will retrieve corresponding information from a data source (e.g., via the Internet). Code scanning or information retrieval is discussed in U.S. Pat. No. 6,851,611; U.S. Pat. No. 6,761,314; and U.S. Pub. 2011/0226850, the contents of each of which are herein incorporated by reference in their entirety.

An inventory manager can be provided by a server apparatus to store consumer product registrations and cause communications to be received by a consumer.

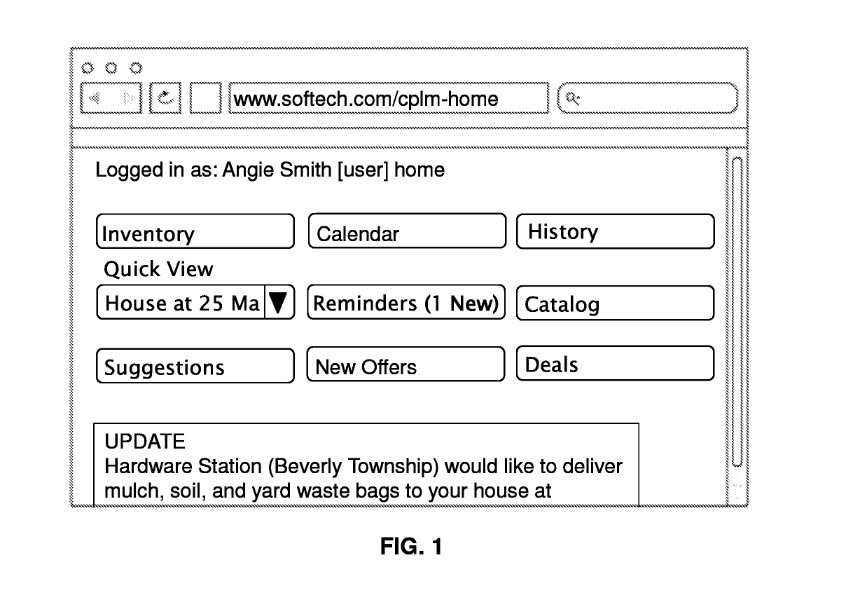

A consumer can create an account and register one or more possessions. FIG. 1 shows a home screen displayed by an inventory manager according to certain embodiments of the invention. In certain embodiments, a user can view a home screen that includes a menu of buttons or links that can be used to see the user's inventory, see a calendar of upcoming events, see a history, view a registration, see upcoming reminders (i.e., a communication), view a catalog, see suggestions, new offers, deals, or other useful information. As shown in FIG. 1, a pull-down menu offers a “quick view” way of seeing a registration for a certain possession.

A registration will generally have at least one associated event date, and for each event date, at least one communication will generally be received by the consumer. A possession can be any item, such as a house or a car. For example, a consumer can register a vehicle and cause the system to schedule future events corresponding to service events for the vehicle. As the time for the service event approaches, the system can send a communication to the consumer including information about the service event.

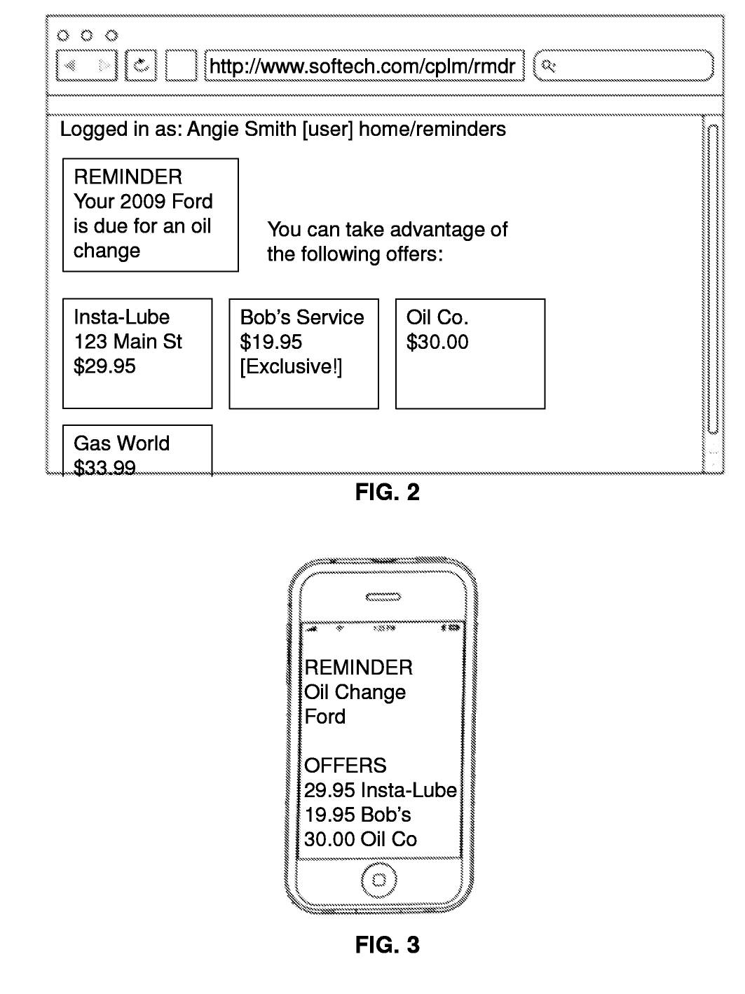

FIG. 2 shows a communication that has been relayed to a consumer including offers. Here, a consumer has registered a 2009 Ford, which is now due for an oil change. A communication can include a reminder, but can further include information from a provider (e.g., an offer) and in some embodiments, can include other complementary information. This enables providers to make feature-rich, multi-part, multi-party offers. The inventory manager can match provider information to consumers based on their possessions thereby enabling consumers to know of specialized services or suitable providers at a critical time. The inventory manager can also allow providers to structure or manage their communications or offerings in complex ways over time.

Systems of the invention can provide consumers with a valuable service. For example, a consumer may list a phone or other electronic device. Subsequently, a consumer may see a blinking light on their device, and not know what it indicates. Here, systems of the invention allow a provider to supply information targeted to a consumer who, for example, purchased a specific phone. For example, a manufacturer could distribute an operator's manual or a video clip showing what the blinking light indicates and how to respond to it. This can be particularly useful where, for example, software or an operating system on an electronic device is updated to introduce new functionality that a user may not already know about.

As more products come to market with an electronic component, systems of the invention represent a natural hub, or “through point”, by which a consumer can manage their possessions. For example, clothes washers, refrigerators, video game consoles, and baby monitors are just a few products that have an electronic component and possible network connectivity now. Systems of the invention offer an information platform to assist in coordinating events associated with these devices. Where a consumer purchases, say, a washer/dryer combo (or any other appliance) with a connected or electronic component, the consumer may register this asset in the inventory manager. Then, electronic data produced by the appliance or device can be received into the system and contribute to information being communicated to the consumer. Thus, a consumer may use an app on their smartphone to receive communications from the system. FIG. 3 illustrates a communication that is relayed to a consumer via an app on a smartphone. The app may notify the consumer every few months when a car needs an oil change, but it may also notify the consumer when a washer is done washing a load of laundry. Further, because the consumer is registered as an owner of a particular brand of appliance, a manufacturer may recognize that that consumer is inclined to receive communications about deals on other appliances of the same or related brands. To illustrate through an alternative example, a consumer may purchase high quality hiking boots for $250.00 and register that asset. Systems of the invention can schedule an event for five years later and then transmit information to the consumer, say, four years and six months later, suggesting that the consumer have their boots re-soled. The consumer may also receive information each spring notifying them that a certain mountain trail is open for the season. Such a communication may further include information from another provider offering the consumer a deal on a tent. Item data handling is discussed in U.S. Pat. No. 6,850,149; U.S. Pub. 2005/0177387; U.S. Pub. 2005/0108286; U.S. Pub. 2010/0287059; and U.S. Pub. 2009/0072991, the contents of each of which are herein incorporated by reference in their entirety.

Besides creating, sending, or relaying future communications pertinent to an asset, the invention provides systems and methods for managing personal inventories of assets.

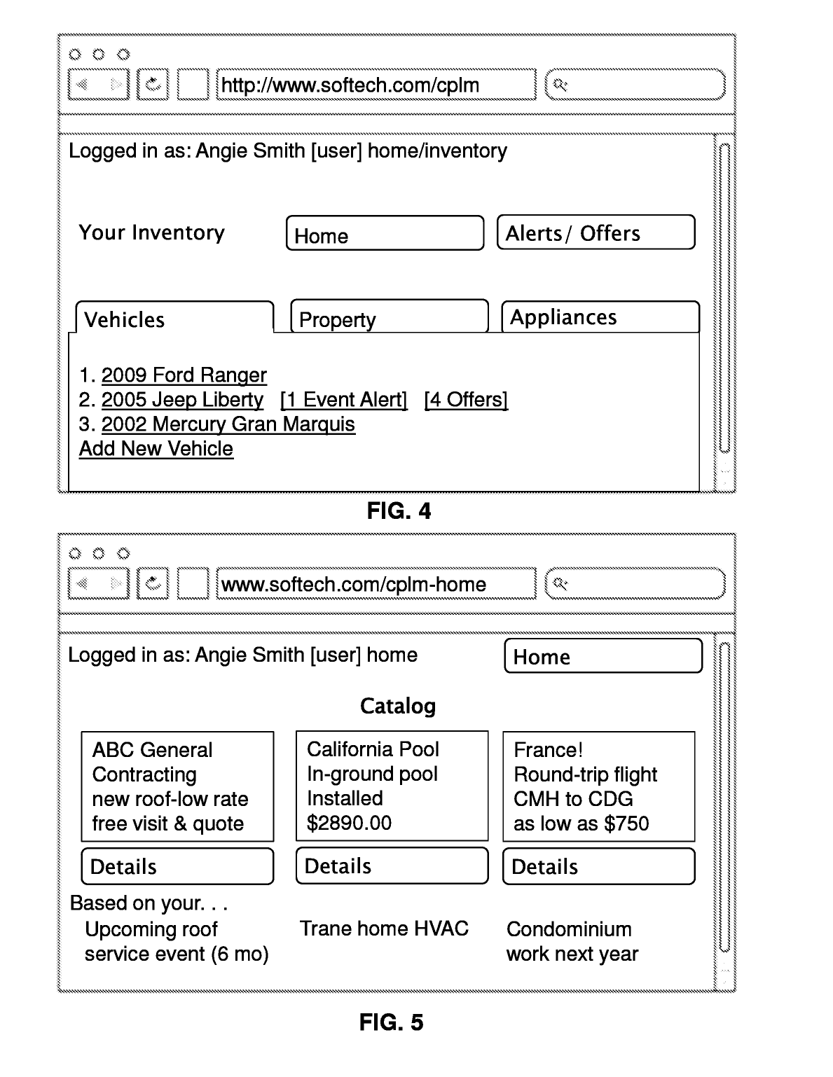

FIG. 4 shows an inventory including a list of registrations that has been composed and sent to a display. As can be seen in FIG. 4, a consumer may organize their possessions by categories (e.g., vehicles, properties, appliances, electronics, documents and contracts, animals, etc.). From the inventory screen, a consumer can click on the listing for an item to be taken to its registration page or to a screen to receive any communications or updates associated with the item (noting that an inventory screen as shown in FIG. 4 may be rendered in a different manner as suitable, e.g., when on a smartphone).

Systems of the invention aid a consumer in staying abreast of required due dates. For example, it is not uncommon for a family to own three or more cars. In some states, each car requires annual attention in the form of inspection stickers, DMV registrations, and insurance. By registering each car, a consumer can receive timely reminders about these events. Further, each reminder can include a link to an appropriate web site for assistance or more information. Through registration of a particular make and model of car, a consumer may also be notified of, for example, safety recalls.

A significant advantage of the invention is that all of the various examples disclosed herein may be channeled through a centralized application. Thus, a consumer may receive information about car inspection stickers, their wash being done, their hiking boots being ready for re-soling, as well as reminders to have a furnace filter changed and information about their newly updated operating system all through a single source. In other words, an organized, systematic, intelligent system for managing a consumer's tasks as it relates to assets registered in the database.

A further feature and advantage of the invention includes, because a number of future needs of a consumer are anticipated and channeled through one resource system, the collective efforts or offers of a variety of relevant entities can be marshaled in a unified manner. For example, where a plurality of providers have related or disparate offerings, these can be composed into a catalog to be shared with a consumer.

FIG. 5 shows a catalog that has been generated and sent to a display. In certain embodiments, a catalog is created by allowing providers to pay and compose a catalog entry. A catalog is then composed of catalog entries. Composition includes selecting entries that relate to a user's interests in some way. For example, providers can identify certain possessions or categories of possession that they associate themselves with. Then, an entry by that provider can be selected for inclusion in a catalog for users who have such a possession.

Another feature and benefit of the invention is the ability to collect myriad data points into one record. Service histories, subjective comments, photos, information about vendors, and upcoming event dates can all be accessed through a single point. A consumer user can access the registration record of a possession to see, for example, upcoming service dates.

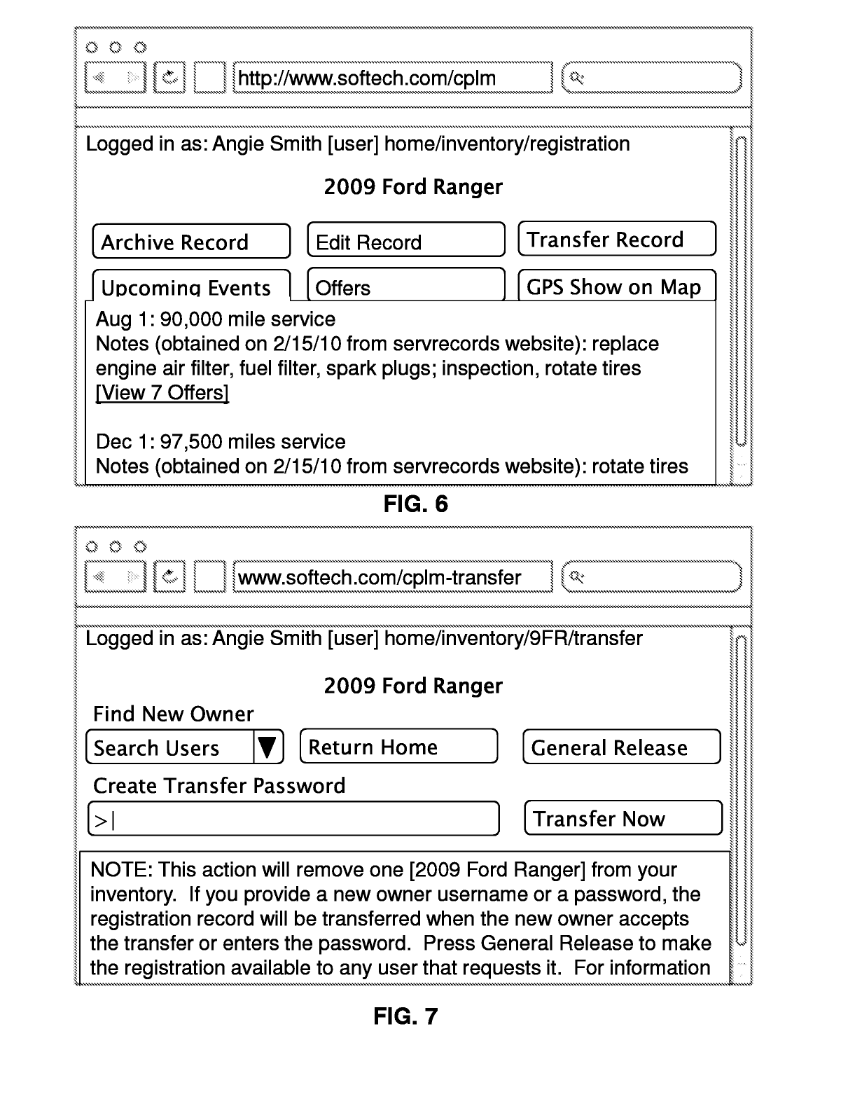

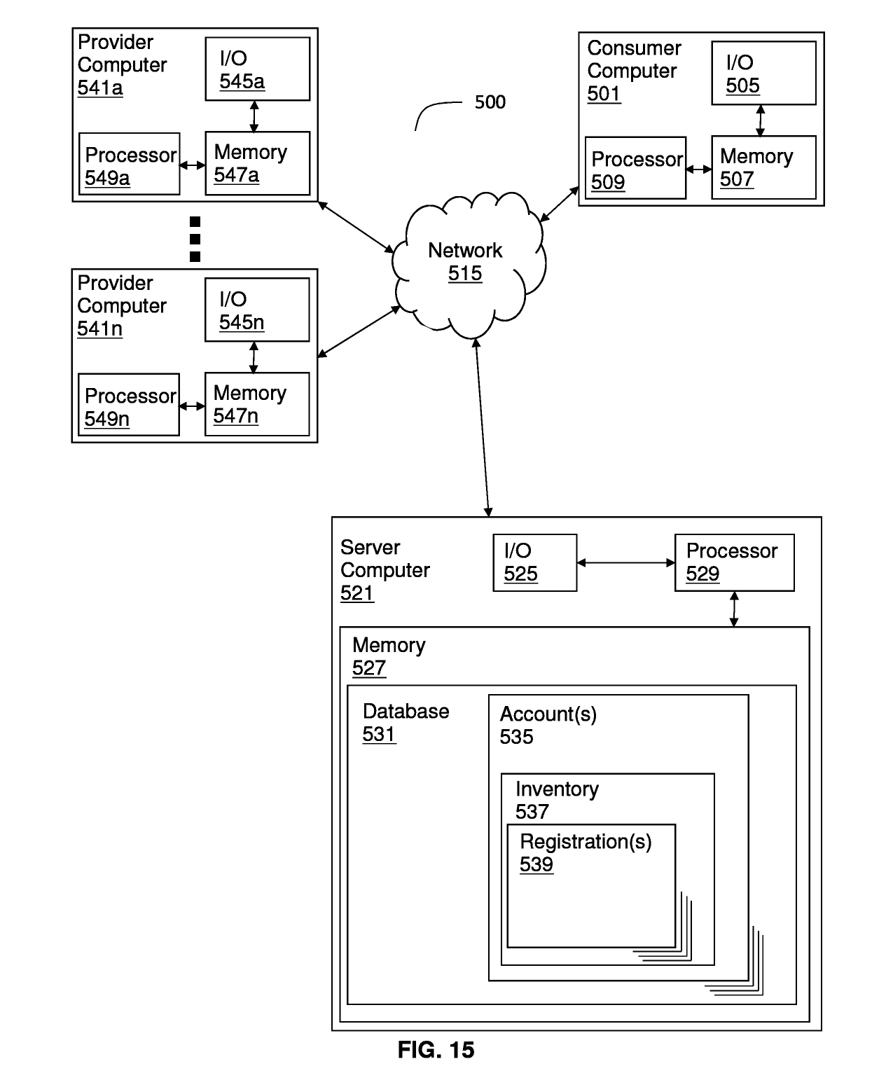

FIG. 6 shows portions of a registration that have been composed and sent to a display according to certain embodiments of the invention. Any suitable method for creating such a system can be used. In certain embodiments, the invention includes a database 531 (FIG. 15) created in, for example, structured query language (SQL). A registration such as that shown in FIG. 6 can include the data relevant to the product. Here, for example, a user could type in that they own a 2009 Ford Ranger, or they could browse to a web site of the Ford Motor Company, find a web page for the vehicle, and import data automatically from there. As a user owns a possession and as time passes, the registration record may tend to become more personalized or customized to that particular possession. At some point, the registration record itself is a valuable extension of the possession. Accordingly, the invention can take advantage of the structure of database 531 and transfer a registration from one owner to another. In certain embodiments, database 531 is created in Microsoft Access as a relational database, and transferring ownership involves changing the relationship between the possession record and the first owner record to a second owner.

FIG. 7 shows a screen that allows a user to initiate a transfer. As shown in FIG. 7, the user is the first owner, and the screen is used to transfer possession away from one's self. The invention further provides screens by which a new owner can initiate transfer of a possession to themselves, particularly where permission are so structured (e.g., after a first owner has hit “General Release” (FIG. 7) or set appropriate permission levels).

For a variety of types of possessions, particularly “big ticket” possessions like cars and houses, lifecycle management is most effective when the lifecycle is viewed over the life of the possession, not just a specific person. One insight of the invention is that, by creating a digital record of the property, and by allowing that record to maintain a cohesive form throughout successive ownerships, product lifecycle management for consumer possessions can be most efficiently and effectively implemented. Thus, the invention provides a computer-based system for managing a lifecycle of a possession that includes documenting a transfer or giving a new owner valuable information.

In certain embodiments, an owner may transfer a registration to a new owner and that transferee is a buyer of the item. For example, a person buys a laptop from a web site and creates a registration for themselves and subsequently gives the laptop to a relative as a gift. At that point, the person may transfer the registration to the relative. In some embodiments, a registration is transferred from a maker of an item. For example, an automobile company may create a digital registration file for each car that they produce. When a person buys a new car, the auto company may transfer the registration file to the buyer.

Creation of registrations for a product line can include object oriented programming methodologies. An auto company may create, in an object-oriented programming environment, a vehicle object and then—for example, as a nascent vehicle travels down an assembly line—copy the vehicle object and, using a computer processor, imbue it with attributes that correspond to the nascent vehicle. The resulting digital file can include information inherent in the vehicle (model, trim level), information about the vehicle (VIN, a digital copy of an owner's manual), or a service schedule.

When a registration is transferred (whether from a maker or a previous owner), the recipient consumer can receive significant value and benefit from the information contained in the registration and the functions provided by methods and systems of the invention. A consumer can register a car and, ten years later, get a reminder to change the timing belt and water pump. Reminders can be sent via email, as calendar entries, as information transmitted within a program or mobile app of the system, text/SMS messages, or other. The new owner can receive detailed records, service history, or future events including, for example, architectural drawings, device specifications, make and model of parts, any or all scheduled event dates, identity of a builder, identity of a service-person, identity of an architect, and device serial number.

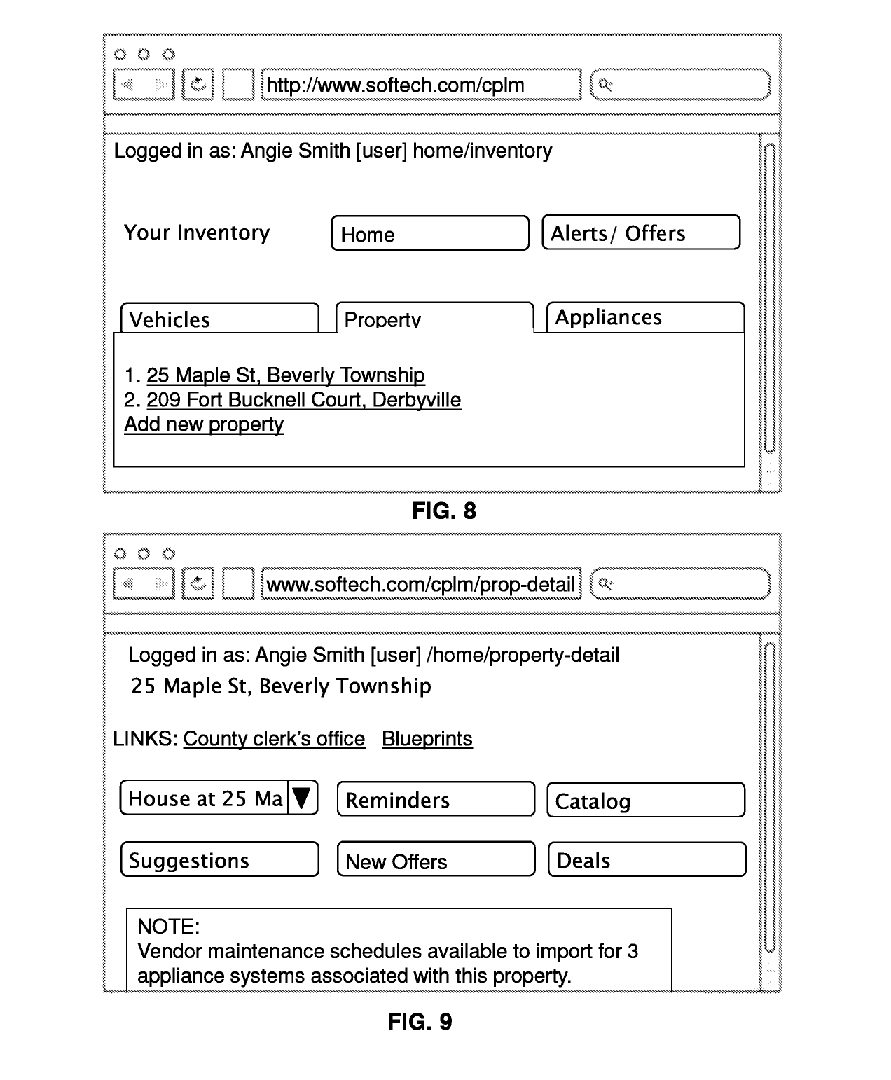

Transferring a registration may provide particular benefits for certain categories of assets or in certain business contexts. For example, a seller can transfer the registration of a house to a buyer, thereby giving the buyer the entire “file history” of the house. For example, FIG. 8 shows an inventory of properties and FIG. 9 shows a detail view of a property at 25 Maple St in Beverly Township. A buyer who has recently purchased this house and added the existing registration to their inventory could now find convenient links to useful information such as the web site of the county clerk's office or blueprints. A buyer could find a service history or contact information for suggested vendors to aid in maintenance. Further, a registration transfer can be repeated for successive owners of the possession. Thus, systems and methods of the invention can be used by a purchaser of an item to enhance the value they derive from the item by giving them a valuable tool for product lifecycle management.

In certain embodiments, a retailer will cooperate or participate in the system. For example, a sales firm may provide a consumer with a registration of a product at the time of purchase. In a brick-and-mortar setting, a consumer could purchase an item (e.g., an appliance) and the selling company could transmit corresponding information about the appliance to a registration file on behalf of the consumer. The consumer could then access the system and verify the registration, thereby signing up for information about scheduled events relating to that asset. In an e-commerce setting, a consumer could buy or order a product over the Internet (e.g., using a web site) and the company that operates the web site could transmit the corresponding information to a registration. In each of these examples, the information could be transmitted by the retailer or instead transmitted by a wholesaler or manufacturer, for example, where the retailer (e.g., brick-and-mortar store or e-commerce company) relays the appropriate information to the wholesaler or manufacturer. Updating personal inventory at transactions is discussed in U.S. Pub. 2005/0060236, incorporated by reference herein in its entirety.

Every function of the invention can be covered by appropriate privacy and security measures to maintain the anonymity of a consumer. As an example, where a consumer purchases a product and the retailer relays appropriate information to a wholesaler to allow the wholesaler to provide the product information for the registration, the retailer—due to their participation in the system, for instance—could transmit a code that represents the consumer, and the wholesaler could relay the product information into the system with the code, without knowing the consumer's identity. Systems of the invention could then decode the code and register the product information in association with the appropriate consumer.

In certain embodiments, systems of the invention are disposed to work in cooperation with other information-based services. For example, a consumer could establish an information connection with their bank, or with a personal finance service such as Mint (from Intuit Inc., Mountain View, Calif.), whereby their purchase transactions are recognized by the connected institution supplying the information to the system to contribute to asset registrations.

Systems of the invention operate to coordinate events, communications, and transactions among parties, which can include one or more consumers, providers, groups (e.g., communities, discussed in more detail below), outside firms (retailers, wholesalers, banks, etc.), or administrators of the inventory manager. Preferably, consumers and providers are configured to communicate with modules of the invention or each other via a network. The network can be, for example, the Internet, 3G or 4G cell network, a corporate network, or an intranet. The consumer can be, for example, a customer that purchases/uses products or services provided by the provider. Likewise, the provider is, for example, a provider of products or services to the consumer (e.g., Acme Supermarket).

The consumer preferably has a profile and an associated inventory, although neither is strictly required as generally a registration provides the basis for operation of the invention. The personal inventory can be used if the consumer wishes to manage the lifecycle of multiple products. A registration or a personal inventory is preferably a logical file, and can be hosted by the inventory manager. Alternatively, either a registration or a personal inventory can be downloaded and reside on a computer of the consumer. For the latter case, contents of one or more instances of the registration or personal inventory can be synchronized. While only a single consumer is discussed in certain embodiments, more consumers (e.g., each with their own corresponding profiles, inventories, or registrations) are possible.

While the inventory manager generally can be configured to cause a consumer to receive a communication, which can be, for example, content that the consumer has generated (e.g., “get an oil change”), the invention generally provides for the inclusion of additional information from a provider. A provider is generally an individual or organization that offers products or services. In general, a merchant is a provider, but provider further refers to other entities including, for example, libraries, police department, the Internal Revenue Service, a pastor, or a cloud computing service.

A consumer may realize benefits of the invention by maintaining an inventory of their tangible assets or possessions, particularly where products or assets are identified with detailed information. One benefit of the invention is that a consumer may re-purchase an exact same or closest match product without having to remember over time precise details about a product. For example, a consumer may buy certain shirts for work or a certain kind of outboard motor. Later, even years later, a consumer may wish to buy more of a product and only know that they wish to mimic what they have purchased previously. By accessing information from a registration, systems of the invention can aid a consumer in finding the same or similar product again. For example, a shirt or motor that is registered can supply the information with which systems of the invention identify online retailers offering the same product. For a consumable product that needs routine replacement (shoes, brake pads, vacuum cleaner bags) systems of the invention can regularly offer the consumer a suitable replacement or can be configured to automatically purchase it. Information registered into the system regarding a home including paint colors, service schedules, repair history, architectural drawings, building permits, plumbing, electrical, heating, air conditioning, service providers, lawn care, smoke detectors, alarms, codes, utility providers, sprinklers and all other useful information could be invaluable to successive owners of the property.

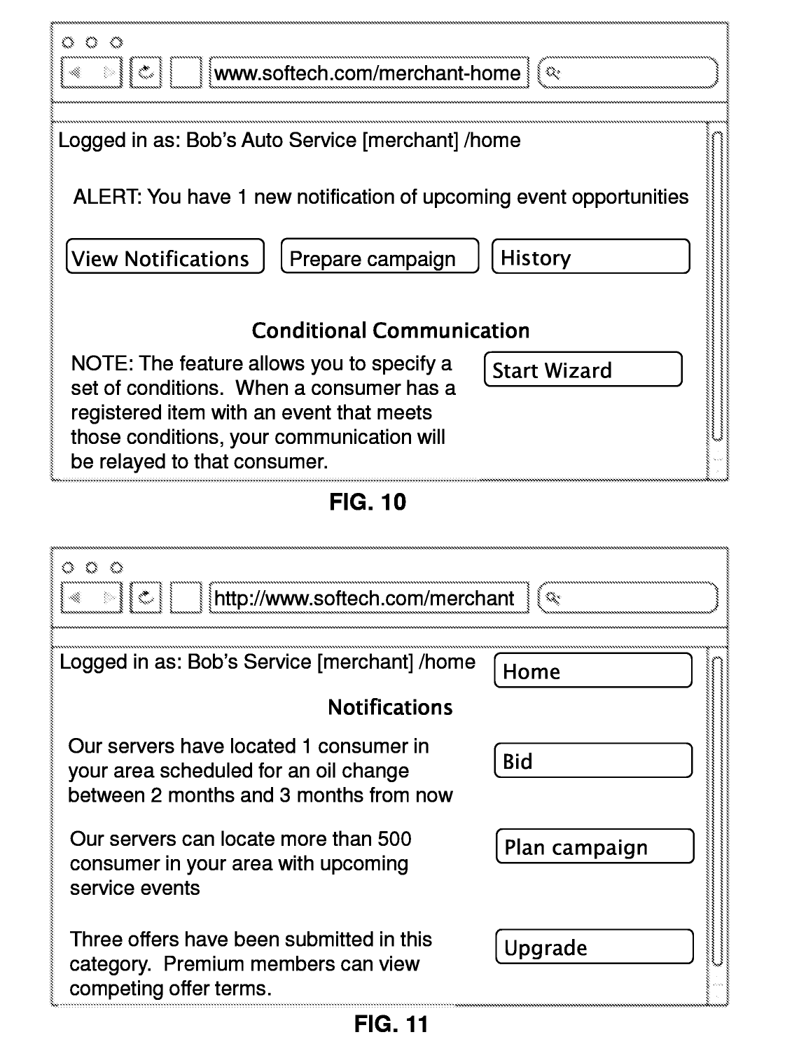

A provider may realize benefits of the invention by being notified of opportunities to send a communication to a consumer. FIG. 10 shows a home screen for a provider. A home screen can be shown to a provider when a provider logs into their account. As can be seen in FIG. 10, a provider can receive and view notifications, prepare campaigns (by which they compose an ad or similar and have it shown to a composed distribution list), or build a conditional communication (a communication such as an ad that is sent to a consumer when the consumer has a possession with an event date that meets certain conditions).

An example of a provider who may wish to send conditional communication would be a provider that winterizes boats. Such a provider might supply a criterion that includes consumers who have registered boats who live in the New England area. The provider may wish to deploy an offer to consumers that satisfy that criterion. Satisfaction (or not) of one or more criteria can be performed by a computing device or machine, for example, automatically, via a processor executing instructions and operating on data. In certain embodiments, the criterion is satisfied implicitly (e.g., the consumer is a person using the system, or the consumer has purchased a product of a certain category).

In certain embodiments, the invention provides systems and methods for notifying a provider of opportunities associated with consumer possession events that meet certain criteria. FIG. 11 shows a notification screen for a provider. Notifications may be received by a variety of means, such as through a notification screen as shown in FIG. 11, or via email, SMS, or other means. As shown in FIG. 11, a notification can inform a provider that a consumer (e.g., within a certain geographical area) is due for an event of the type, for example, that the provider is in the business of servicing. Further, as shown in FIG. 11, systems and methods of the invention can notify a provider of an aggregate number of consumers that meet certain criteria.

Because of the value in being able to send communications to consumers right when they become aware that an asset needs attention, providers benefit from systems of the invention. Providers may further be encouraged to create an account or participate in systems due to business opportunities or competitive advantages offered by methods and systems of the invention. For example, the invention provides computer programs that can allow member providers to see the bids (e.g., the lowest outstanding offer, all offers, etc.) of other providers. This way, a member provider has an opportunity to make an offer and receive business that they may not otherwise receive.

A particular insight of the invention is that methods and systems can operate to send notifications and communications (e.g., offers) in the run-up to an event in which a consumer needs a product or service. Further, the conditions necessary to send these notifications or communications can be established before (e.g., years before) the consumer's need arises. Thus, systems of the invention operate to anticipate a person's needs and have a carefully selected provider at the ready to service those needs, or even to have several providers bidding competitively to service those needs.

Once bids are submitted (offers are made) the consumer can select one. In certain embodiments, consumers make selections extrinsically, or outside of the computer system. For example, the communications relayed by systems of the invention contain offers from providers that include sufficient contact information that a consumer simply goes to, or calls, the provider. In certain embodiments, the consumer selects an offer within the system—choosing an offer via a computer. The system can proceed to schedule a service date or refer the consumer or provider to a payment system or even to process payment.

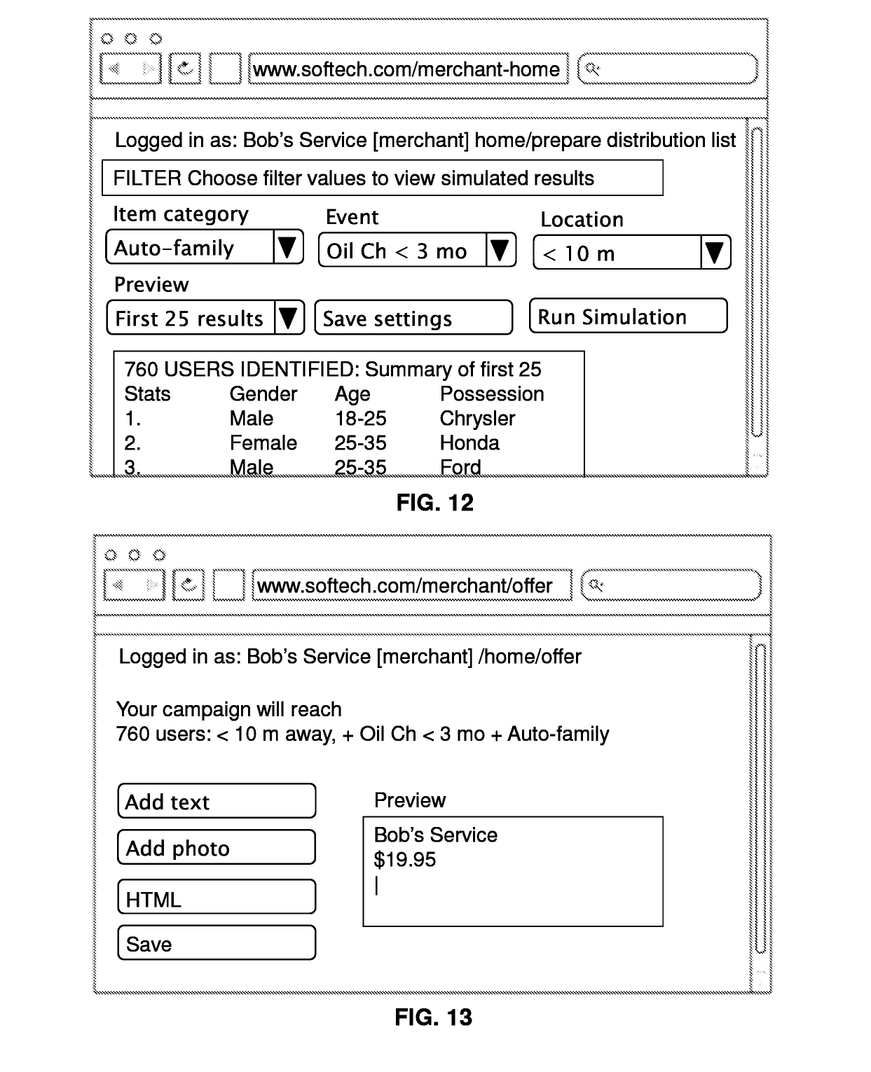

In certain embodiments, systems and methods of the invention allow a provider to prepare a campaign of communication targeted at a relevant group of consumers. A provider can establish values for any number of parameters (consumer location, possession type, consumer age, possession age, next service date, etc.) and have the provider's communication be relayed to a group of consumers matching the criteria (i.e., sent to a distribution list). FIG. 12 shows a screen at which a merchant can prepare a distribution list. As shown on FIG. 12, a merchant can set parameters and then choose to “Run Simulation”, which may produce a list of results or a summary of results letting the merchant provider know who their communication will reach (e.g., if they pay to use the distribution list, i.e., by entering credit card information into the system, composing an ad, saving it, and then sending it to the distribution list).

FIG. 13 shows a screen at which a provider can compose a communication. The screen shown in FIG. 13 can be used to compose a targeted advertisement, a general ad, or any other kind of communication. For example, a police department may use the system to transmit a missing persons alert to, for example, all females over 35 in a certain zip code. In another example, an auto company that offers a digital registration file with each new auto purchased may use the system to notify consumers of a recall. A person from the auto company may use the screen shown in FIG. 13 to compose a recall notice and transmit the communication to every registered owner of a certain model of car.

Using a screen such as that shown in FIG. 13, a provider can supply information to be included in a communication that a consumer receives. The information can include, for example, instructions on how to exercise an associated offer (e.g., “print this coupon”), any effective or expiration date of the offer, any complementary offers that can be associated with the purchase of the offer, and any date-dependent variations. One example of offer information responsive to criteria would be a manufacturer and installer of photovoltaic cells that screens for consumers who have houses registered in ZIP codes and for utilities in those ZIP codes that have recently dramatically raised electricity rates. Thus it can be appreciated that provider criteria can relate to extrinsic (sourced outside of a registration) as well as intrinsic information. One example of a date-dependent variation is “10% off in the first week, 20% off in the second week, then 30% off in the third week.” While only a single provider is discussed here, more providers (e.g., each with their own corresponding information) are possible. In some embodiments, aspects of the invention include or are organized around communities, which are discussed in more detail below.

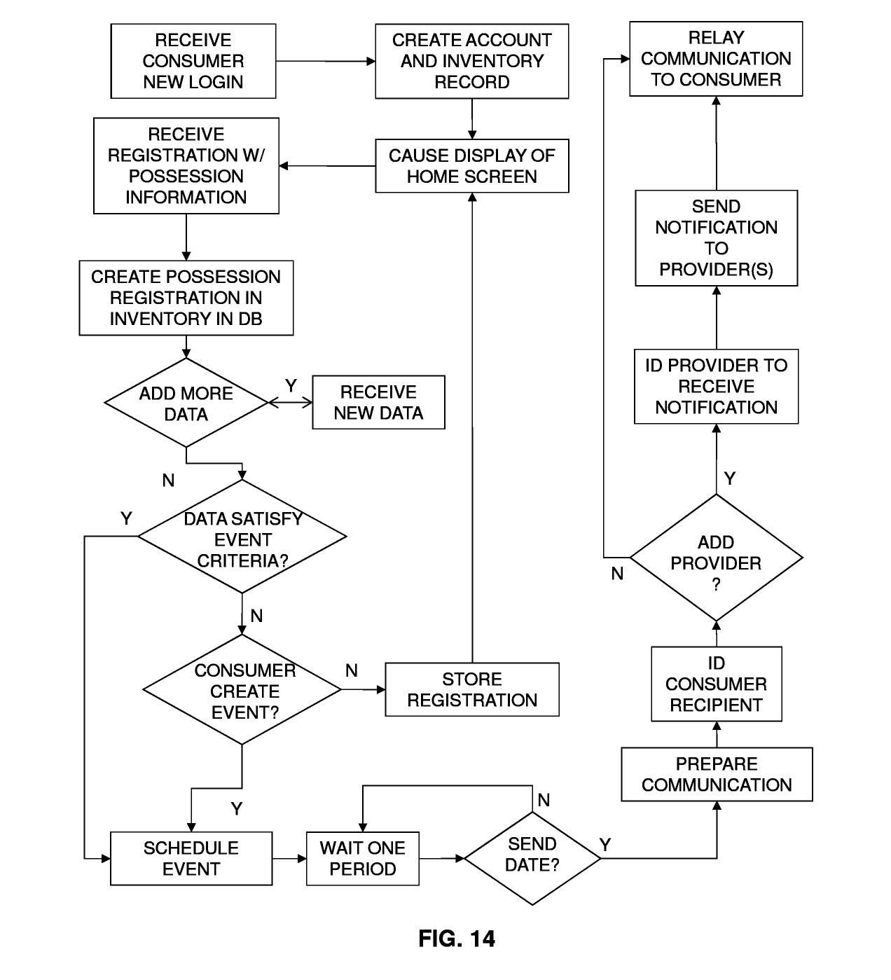

Systems and methods of the invention can be implemented using a computer (e.g., server computer 521 shown in FIG. 15) programed according to known techniques to implement steps of the methods. For example, in certain embodiments, the invention provides methods that include steps included in the methodology diagramed in FIG. 14.

As shown in FIG. 14, methods can include receiving a new login by a consumer and creating an account that includes an inventory record. The consumer can be shown a home screen (e.g., FIG. 1), and a computer (e.g., server computer 521) can receive a registration as discussed above. The registration is added to the consumer's inventory and any more data is added over time as and whenever a consumer may choose to do so.

When data in the registration satisfy certain criteria (e.g., a rule such as “if type=auto then create oil change event with date 3 months in future”), an event is scheduled. Also or in the alternative, a consumer can schedule an event, causing an event to be scheduled. An event, generally, is a digital record with an associated date in the future of when the event is created and associated information. When the data arrives (here, in FIG. 14, called a “send date” because it is a date at which communication is sent) a communication is prepared. Preparing a communication can include retrieving a communication composed by a provider (e.g., using tools illustrated in FIG. 13) and queuing it to be relayed to a recipient. The relevant consumer is selected based on the event or associated registration, and the communication is relayed to the relevant consumer. In certain embodiments, at least one provider is notified when a certain criterion is reached (such as a consumer having an event date).

As discussed above, a communication can be a reminder that a service date is approaching and may include an ad for service. Other timely or relevant information relates to product warranties. A consumer who registers a product that is under warranty can receive communication that suggests a service or sale at times that are logically connected to warranty-based events. For example, a registered owner of a car could receive a suggestion to sell their car six months before the warranty expires. A consumer that is a registered owner of a car under warranty could receive oil-change reminders that refer the consumer to an approved dealer while the car is under warranty, but then refer the consumer to an inexpensive or convenient dealer after the warranty expires.

Another insight of the invention includes the ability of the consumer to block offers that fail to meet certain price requirements or that allow the vendor to view the last best offer made to the consumer. By providing vendors with information regarding the best deal that is currently open to the consumer other vendors can decide to compete or not compete. In one illustrative example, a consumer may have a house with a roof that needs to be re-shingled. One provider could have information relayed to the consumer including an offer to do the job for a certain price, say, $10,000. The relayed information could further include the information that this represented a discount (e.g., 25% off) from the provider's regular price. One or more other providers could view that this offer had been made or the offering price, and could choose whether or not to also send information to the consumer including, for example, an offer. In this regard, systems of the invention could provide consumers with competitive (literally) offers for goods and services at significant or appropriate times.

In further exemplary embodiments, the ability to see “last best” offers can be offered to one or any provider, or can be offered to select providers. FIG. 11 shows a screen that includes a report to a provider that three competing offers have been submitted, and gives the provider an “Upgrade” option that would allow them to view those competing offers. For example, provider P1 could be a registered user or featured participant while provider P2 could be an unaffiliated third-party. In this example, provider P1 could see best offers by all providers in the category of P2, but provider P2 could not see best offers of providers in the category of P1 (e.g., registered providers, favored providers, providers given certain permissions by a consumer). By deploying this optional feature of organization, systems of the invention can reward or encourage participation, ultimately bringing goods and services to consumers in a more effective and efficient way.

It can be appreciated at least from the foregoing example that the invention provides the ability for consumers or providers to set permission levels or access levels or to establish parameters limiting or allowing communication or information flow. For example, a consumer can establish a parameter to prevent any given piece or category of information from their profile to be accessible by any given provider or category of providers. Thus, a consumer could group information that identifies a geographical location, buying history, or personal net worth, and restrict access to that group such that no provider could see related information. Accordingly, scheduled events associated with ownership of houses of certain value or in certain location could be kept private from certain providers. Further, providers can be grouped by categories (a list of named providers, those providers with whom a consumer has not previously dealt, providers in certain industries).

One insight of the invention includes the ability of consumers to structure their participation so that they receive a controlled amount of information, which information preferably has a nexus to their needs or is associated with a source that is reputable. For example, in registering a car, a consumer may establish that they want to receive no more than 3 communications per year, and that additional information within those communications should be associated with no more than two providers. Further, in some embodiments, the very fact that a provider is a participant in the inventory management system will give the provider the imprimatur of legitimacy that causes their communication to be welcome. For example, where the implementation of the invention is performed by a firm that maintains its good reputation with consumers, a consumer may be inclined to look favorably on information transmitted on behalf of a participating provider.

As discussed above and throughout, the invention provides systems for managing the lifecycle of a possession. FIG. 15 is a diagram of components of a system 500 according to certain embodiments of the invention. As shown in FIG. 15, methodologies of the invention can be implemented by a server computer 521 using an input/output device 525 such as an Ethernet connection (e.g., via a 10/100 network interface card) in communication with at least one processor 529 coupled to a memory 527. Input/output device 525 can allow server computer 521 to communicate with any or all of consumer computer 501 and provider computer(s) 541a, . . . , 541n. While shown here as it relates to a single consumer, one of skill in the art will appreciate that any number of consumers using any combination of any number of consumer computers can interact with components of system 500. Also, provider computer 541 and consumer computer 501 are here distinguished by name, but need not be separate or different machines, as will be recognized by one of skill in the art.

Components of the system can be configured to facilitate the interaction among consumers and providers, and can also be configured to host, maintain, and/or manage one or more of the registration, inventory, profile, interface, communications, supplemental content such as complementary information, communities, activity or history logs, groups, or other. The inventory manager firm may receive from the provider a commission fee for, for example, finding the consumer. The commission fee can be a fixed fee, a certain percentage of a purchase price, and/or in any form agreed upon between the inventory manager firm and the provider. The inventory manager firm can share the commission fee received from the provider with consumers or communities that help promote the service and attract further consumers or providers. Preferably, parties can interact via a consumer computer 501 (e.g., personal computers, commercial POS or cash register devices, portable computers, mobile phones, smart phones, kiosks, etc.). The consumer can input registrations and receive communications through an input/output mechanism 505 (e.g., keyboard, trackpad, and monitor) of computer 501 (which includes memory 507 coupled to processor 509). Providers can supply information or—in certain embodiments—test criteria through one or more of provider computer 541a, . . . , 541n, which each include an input/output device 545a, . . . , 545n for operating processor 549a, . . . , 549n coupled to memory 547a, . . . , 547n. Suitable hardware for use in components of systems of the invention is discussed in greater detail below.

An inventory manager can be structured to include one or more of a number of modules for maintaining inventories, consumer profiles, provider profiles, functions such as matching providers to consumers, executing or relaying communication, security and permissions (anonymity), statistics, reporting, and data management. The inventory manager can also be connected to or include a database, which can be part of a same server computer as, or can be located remotely (e.g., across a network and operated by a third party) from, the inventory manager. While certain functions are described as being included in modules, one or more of the modules can be omitted in certain configurations. Also, while each of the modules are conceivable as separate functional blocks, the functionality provided by each can be combined into a single functional, or logical unit. Furthermore, the modules or functions can be hosted or otherwise provided by a single computer (e.g., a single server) or using multiple computers (e.g., using a cloud configuration).

The inventory module generally operates or includes a database to manage consumer registrations. Preferably, the consumer can provide registrations containing information identifying possessions that can be used by a provider to generate information that the consumer would like to receive. For example, a consumer's inventory can include a horse and an airplane. A firm that sells custom built boats may want to provide information to consumers who have registered either a horse or an airplane. A module of the invention can match these parties, or offer anonymous data to the provider who chooses which consumers fit their criteria.

In some embodiments, the invention provides a matching module, which can be configured to perform the matching of consumers to providers. The matching module can be configured to match information from the provider with consumers that have registered products that satisfy a criterion or have indicated a willingness to receive certain information. When the provider seeks to target consumers, the provider can supply criteria, which can include key words, property categories, or demographic information. A provider can supply “interest phrases”, keywords or tags designed to be matched against a similar set of phrases supplied by a consumer.

Conversely, consumers can limit the universe of potential providers that will communicate with them through the provision of exclusion rules or boundaries. Consumers can define rules based on keywords (e.g., typing in or clicking on “interest phrases”) or exclude providers by name, by category, by ranking according to a third-party or internal service.

A match is preferably found based on a set of rules. One exemplary rule can be-there must be an exact match between interest phrases of an offer and an interest of a consumer. Another exemplary rule can be -there must be a match between interest phrases of an offer and a portion of an interest of a consumer while the interest can have other non-matching terms. The matches are preferably recorded.

Where rules and criteria are satisfied, information from a provider may be relayed to a consumer. Generally, the invention provides that information will be transmitted to a consumer. That information may include, for example, an email, a calendar pop-up or reminder, a text message, or some other form of electronic reminder. In some embodiments, systems of the invention will send the communication. In some embodiments, systems of the invention will cause the communication to be sent (e.g., triggering a calendar that the consumer uses to show a reminder). In this regard, information from a provider is said to be relayed. Such information generally originated with the provider and is received by the consumer. It may be emailed from the provider to the consumer subject only to a level of security or password protection provided by systems of the invention. In that regard, in certain embodiments, systems of the invention do not send the information, they are, however, necessary for the relay of the information. In certain embodiments, information from the provider is never gleaned by, accessed by, or stored within systems of the invention. In alternative embodiments, a provider provides information that is stored within systems of the invention and, when appropriate criteria are met, systems of the invention transmit that information to a consumer.

In some embodiments, the information from a provider is an offer, i.e., to sell a product or service, and the consumer may accept. In certain embodiments, this results in a transaction, which can be facilitated, at least in part, by systems of the invention. A transaction module can be configured to execute a transaction between the consumer and the provider. In one embodiment, the transaction module can transfer control to a website of the provider, passing to the provider information required by the provider to execute the purchase associated with the offer. Once the purchase transaction actually takes place, the transaction module may then receive the information about the purchase transaction from the provider. This information can then be recorded or stored.

In another embodiment, the transaction module can transfer control to a computer or website of the provider, passing to the provider information required by the provider to assist the purchase transaction. The website of the provider can then pass the same information and any additional information back to the transaction module, which can ensure that all conditions of the offer are met and then instruct the website of the provider to complete the purchase transaction. Alternatively, the transaction module can execute the purchase transaction, then send the purchase information to the provider to fulfill the purchase. Once the purchase transaction actually takes place, the information about the purchase transaction can be recorded or stored.

There can be more than one communication mechanism via which various merchants and various modules of the inventory manager communicate with each other during executions or other phrases of transactions. One example is via web service calls between a provider and the transaction module.

A commerce module can be configured to clear and settle transactions between, for example, consumers, providers, the inventory management firm, or third parties. Each instance of an offer can be associated with information about the fees or commissions due to any party. The commerce module can process all transactions, aggregate the information, and provide the appropriate parties such information as what is owed and to which party. In alternative embodiments (for example, embodiments in which the commerce module is provided at least in part by a firm such as Visa) the commerce module can close or cause to be closed any or all of the payment transactions and notify parties or adjust their balances. The information can be in an aggregate format or in details or both. The commerce module can also keep track of any funds received and any outstanding balances, or cause that tracking to be done in other places, such as within bank computers.

In certain embodiments, the invention provides anonymity or security for a consumer. In general, a consumer may register a product and receive a communication including information from a provider, without the provider ever knowing the identity of the consumer. Further, systems may be configured such that the provider never knows whether the information was transmitted, or only knows summary, aggregate, or demographic data about consumers that received information. Anonymity, privacy, and security purposes can be accomplished by functionality describable as or provided by a security module. The security module can be configured to monitor transaction security, to support auditing, and to prevent potential frauds through a number of processes. For example, the security module can utilize digital signature techniques on information and records stored in the database. Certain possessions that a consumer may register may tend to create targets for crime, fraud, or an unwanted excess of communication. For example, registering vacation houses in multiple locations may invite malfeasance. Registration of certain famous possessions (John Lennon's sunglasses, Action Comics #1) may draw attention from eccentrics, collectors, and gossip columnists. Accordingly, a security module can provide any level of security.

Noting that the invention provides valuable product lifecycle maintenance services outside of its capacity to relay provider information, some consumers may use the invention to register items and exclude any provider information from ever being relayed to them. Even in these embodiments, a security module can employ cryptography and other known methods to ensure that a registrant's identity is kept secret and that registered possessions are also maintained in secrecy.

One insight of the invention is that sophisticated matching between providers and consumers can be made even while keeping any or every aspect of a consumer secret or anonymous. By honoring a consumer's limiting boundaries and conditions, and giving effect to provider criteria, and allowing registration of possessions with detail, including start dates, a precise matching between provider and consumer can be achieved while maintaining consumer anonymity. For example, a consumer could buy and register a share in a racehorse and during a subsequent April, a luxury lodge could offer a suite of rooms in May near Louisville, Ky., during the Kentucky Derby. As another example, a consumer could register that they own rental properties in several different college towns. Subsequently, a carpet installation company in each town could relay an offer to the consumer two weeks before “big trash day” in each town, offering to tear out and replace old carpet. This can be accomplished while keeping the consumer anonymous. Further, in this example, neither the consumer nor the provider need know when “big trash day” is, as, for example, the provider can supply it as a criterion (offer carpet service two weeks before big trash day to rental owners in college towns) and matching modules of the invention can reference appropriate information.

Modules or components of the invention such as a registration, inventory, or profile can be implemented using a logical file that corresponds to the consumer, although other techniques are possible. As shown in FIG. 15, in certain embodiments, memory 527 of server computer 521 will include a database 531. Database 531 will include one or more account(s) 535 for registered users. Typically in some embodiments each account 535 will include an inventory 537, and each inventory will include one or more of registration 539.

While shown in FIG. 15 in a server-based embodiment, the registration or inventory and profile can reside on consumer computer 501 (e.g., a home PC of the consumer). The registration or inventory and profile can preferably include numerous pieces of information corresponding to the consumer. For example, the registration or inventory and profile can include consumer ID, product ID, name, scheduled event date, full lifecycle information, mothball date, start date, community membership, interests, history, income, or others. Identifying information, profiles, registrations, inventories, markup files (XML, HTML) or database output, text files, communication, or information, or any combination thereof, as used herein, can be stored in a database. Storage in a database can be performed by a computer device or machine. Systems for implementing an inventory database are discussed in U.S. Pat. No. 8,032,572 and U.S. Pub. 2008/0120167, incorporated by reference herein in their entirety.

A registration preferably includes a unique ID for the registration (e.g., “RegID”) as well as a UserID identifying the consumer. The registration will generally contain information identifying a possession. In certain embodiments, each possession will receive a unique ID within the system. Thus, for example, if a consumer registers a car and later sells that car to another user of the system, the information specific to that car (e.g., history of oil changes, upcoming scheduled events, etc.) can be transferred to a registration for the new owner based on a ProductID while a new RegID is created.

Systems of the invention can maintain a record of all activities, relays, transactions, or other exchanges in an activity log or history log. A log can also contain any messages and dialogues (e.g., about dispute resolution) that the consumer has with the provider. A log can be configured so that the consumer can remain anonymous.

Using the registration or inventory and profile, the consumer can remain anonymous within the system. In certain embodiments, the registration or inventory and profile can be configured such that it does not contain personal information corresponding to the consumer, nor, preferably, is such personal information required to create the registration or inventory and profile in the system. Preferably, the provider has no knowledge of the identity, or other personally identifiable information, relating to the consumer. For example, preferably the registration or inventory and profile need not include information such as name, address, phone number, or email address. The consumer can remain completely anonymous to the provider before the consumer actually makes a purchase through the provider. When the consumer makes a transaction within the system, the transaction module can utilize mechanisms, such as a single-use credit card number or a third-party freight forwarder, to maintain anonymity of the consumer, if the consumer desires. A consumer can be kept anonymous by concealing their identity. Concealment of an identity can be performed by a computing device or machine, for example, automatically, via a processor executing instructions and operating on data.

In certain embodiments, a consumer can include personal identifying information in their profile, thereby allowing certain parties to conduct certain dealings with them. For example, the inventory manager firm (i.e., the system administrator conducting methods of the invention) may communicate with the consumer. However, the consumer's personal information may be kept secret so that, from the point of view of the provider, it is as if the consumer has provided no personal information.

An operative concept of the invention is consumer product lifecycle maintenance (CPLM). Product (or possession) has been discussed above. As discussed above, a lifecycle generally encompasses the service and maintenance events whereby a consumer realizes their potential enjoyment, benefit, and advantages of a product. A particular insight of the invention is that as a maintenance event approaches, a provider may have specialized information or expertise that would be valuable to a consumer and with an impending maintenance event, a consumer may be amenable to receiving information from a provider that will aid the consumer in CPLM.

In certain embodiments, a provider is thus able to transmit an offer to a consumer at the time that the consumer needs it. However, numerous categories of information are considered valuable by a consumer (notification of a recall, videos showing appealing uses of a product) and thus the invention is generally described as causing a consumer to receive communication including information, and not just offers.

Products and possessions described herein in various examples include so-called big-ticket tangible items, and such items are encompassed by methods of the invention. Further items included in various embodiments include securities, documentary possessions (documents of title), commodities, livestock, wills, insurance policies, leases, contracts, commercial paper, negotiable instruments, liens, security interests, certificated securities, registered securities, intellectual property, currency, proceeds, intangibles such as goals, aspirations, or ideas, as well as digital or fictional possessions such as properties owned within games or registered for demonstration purposes or as proxies.

A communication may generally have a structure including primary content not specific to a provider, which can be, for example, a line, a header, or metadata in an email identifying that the communication is provided through the inventory manager of the invention. (“Primary” content is used not to indicate importance or chronology, but simply to distinguish from provider content, discussed below.) Primary content can be provided by the consumer at registration or solicited by the consumer during registration. For example, a consumer may check a box on a web page during registration that is labeled “Notify me when the five-year maintenance is due.” Then, five years later, the consumer may receive a communication (e.g., mail or SMS) containing the primary content, “Maintenance is due.” Further, the structure of the communication can include additional information from a provider (i.e., provider content), as discussed herein throughout. Further, in some embodiments, the structure of the communication may include complementary information.

In certain embodiments, a communication includes an offer from a provider and at least one complementary offer. The offer, for example, could relate to a critical maintenance task affecting a consumer possession (time to re-roof the house). The complementary offer could relate to a reward offered to the consumer based on their response to the primary offer (re-roof your house with RoofCo today and receive free windows). A complementary offer could have a nexus to the primary offer (pay for ten oil changes now and get 25% off as a primary offer, with free car wash at WashCo as the complementary offer). Separating the primary and the complementary information allows systems of the invention to provide sophisticated and complex support for a user to maintain a product over its lifecycle. For example, where a consumer has a boat that needs routine maintenance, a local provider can offer to perform the maintenance at the time, while a boat restoration firm can notify the consumer about deals on specialty upholstery work. Where a consumer has just registered a LAN for their small business, including registrations for, say, ten PCs, networking hardware, a networked printer, and office software, a supply company can offer to sell or deliver toner routinely while a service firm can offer to upgrade the operating systems in the PCs at an appropriate time in the future. Systems and devices of the invention can identify complementary information or a complementary offer. Identification of complementary information or a complementary offer can be performed by a computing device or machine, for example, automatically, via a processor executing instructions and operating on data. That one set of data or information is complementary to another can be indicated by overlapping keywords, classifications or categories in common (e.g., providers register their information by class and subclass, a call number system, or any other information taxonomy system where complementary means two items are located in a taxonomical group), or by declaration by a provider (e.g., “this information is complementary to File A” or “this information is complementary to all information relating to paintings”).

The inventory manager can be configured to deliver an appropriate communication that is matched to a consumer. For example, a communication can be based on one or more factors such as the consumer's anticipated future needs, registered possessions, stated preferences, and past behaviors obtained from the consumer's history. A particular insight of the invention includes the realization that a consumer can be matched to a provider based on events or information that arise after the matching process is begun. Each registration or inventory and profile can contain a record of all the offers sent to the consumer and the consumer's response behavior for those offers. Over time, based on information gleaned from, for example, tracking prior usage, the inventory manager can compute what aspects of an offer are more likely (e.g., statistically more likely) to result in a sale. For example, one consumer who pre-pays for certain maintenance services may prefer discount coupons on future purchases while another consumer who typically handles things last minute may prefer bonus airline frequent flyer mileage. Providers can use this information to generate more focused offers. As a result, consumers can receive more personalized and user-friendly offers.

In particular, a registration in the inventory manager can contain data, which results in a future need, event, or fact being identified. For instance, registering a new car now can establish a need for new tires in four years. Alternatively, registering a new car now can establish a need that is not even fully realized at the time of registration, but that is fully realized at a time subsequent to the registration, for example, when a product recall is issued or when a component of a product gets overshadowed by a new product that is significantly more efficient or desirable. Thus, in certain embodiments the invention includes methods and devices for obtaining information from a consumer and subsequently obtaining additional information that indicates a need, and matching a provider to the consumer based on the need. In certain embodiments, a consumer registers a possession or tangible asset without contemporaneous knowledge of a future maintenance event of that asset or possession. Systems and methods of the invention create a scheduled event containing information about that future maintenance event and, at a predetermined time prior to the scheduled event date, relay information to the consumer including information from a provider. Scheduling an event can be performed by a computer device or machine and can include writing a file. A scheduled event can be a file, for example, saved in memory. A scheduled event can include actions or activities, which can mean that a scheduled event file includes data indicating actions or activities, for example, by a description or date.

In certain embodiments, a communication includes information from a provider and complementary information from the provider or a second provider. Such so-called two-component communications allow providers to create and support offers that are difficult for merchants to implement on their own. For example, a consumer may purchase a good or service from a provider, and a second provider may provide a free good or service (e.g., as a reward or to introduce the consumer to an offering). In some situations, a provider may offer a deal contingent on, for example, one or a group of consumers spending a certain amount of money with either the provider or the provider and the second provider. Two providers could identify each other as providing related goods and services and offer package deals.

In general, systems of the invention allow providers to assist consumers in maintaining a possession through its lifecycle.

In some embodiments, systems and methods of the invention provide one or more of a community in which a consumer or provider can participate. A community, generally, describes a group of people or entities, which group has a quality in common among most of its members. Providing a community according to the invention can support community-wide interests and offers. A community can be, for example, a virtual Web 2.0 community or any entity including one or more of the consumer. Preferably, the group of consumers within a community share some common possession or category of possession, although this is not required. One example of a community is a motorcycle enthusiast's club. A community allows for offers of goods and services in particular from consumer to consumer (i.e., amateur to amateur); (“You can store your motorcycle in my garage for the winter) according to systems of the invention. A community allows for a communication to be relayed in anticipation of a scheduled event wherein a communication includes know-how (changing the chain on a Honda Rebel). Thus communities provide a context in which communication may be particularly welcomed. Providers may include additional information in community-based communications. For example, a motorcycle parts provider may include information about their offerings in all communications in a maintenance category within a motorcycle enthusiast's community.

Communities integrated with the inventory manager can promote the inventory manager to their community members. For example, a community can present an inventory manager web link on its community website to encourage all community members to create their own profiles, inventories, or registrations (e.g., a link or button labeled “register your tractor here to receive maintenance reminders with information from our most experienced members”). Communities can provide their members community-wide interests, which the communities believe would be of-value to all members. Community members can choose to inherit the community-wide interests as is or to customize their own interests based on the community-wide interests provided.

A community can also preferably create a special form of communication, which can hold a set of community-managed interests. When a community receives offers matching a community-wide interest, the community can have the option to approve or disapprove the offers. Once approved, the offers can be added to an online wall or message board and presented to all community members. When a community member receives offers matched to the individual interests, those offers can also be presented to the member on the community website once the member logs in. Moreover, leveraging its large audience and group buying power, communities can also enlist trusted merchants and encourage merchants to produce special offers.

In some embodiments, the community or group organizational schema applies to consumers who are linked through some external association, for example, all employees of a firm or all students of an institution. An association may aggregate information about employees and provide some of that information to be received by systems of the invention. For example, a consumer may have a profile stored in the database that includes information provided by their employer. Where such information is confidential, it can be kept secure as discussed elsewhere. Systems of the invention can include modules or functions to create profiles for individuals based on information that they receive from an association. For example, a large employer could provide the names and email addresses of a number of its employees, or a university could provide names and student numbers of a number of students. These people could then access services of the invention.

Association-based membership enables bulk pricing models to apply as well as targeted information or offers. For example, a landscaping business that normally charges a rate of $100 per visit could offer all of the employees of an office a discounted rate. In this way, participating consumers would benefit by inexpensive and easily accessible maintenance to their assets (tending the landscaping around a house) through their membership in an association. Further, association-based models enable targeted communication. All of the employees of, for example, a motorcycle dealership may be targeted for offers for discounted winter storage of motorcycles.

In general, the invention allows a consumer to create a personal inventory 537 such as a household inventory or multi-household (i.e., estate) inventory. As mentioned above, the personal inventory can be created without any personal information of the consumer so that the consumer is able to remain anonymous in the system. An inventory manager can provide an intuitive user interface, such as predefined interest forms or guidance wizards, to assist the consumer in defining interests. In certain embodiments, the inventory manager does not require the consumer to download any application to their computing device, although one can be used if preferred. The consumer can search for possessions to register based on a taxonomy hierarchy, search words, or simply typing in a description. For example, a consumer could register a pickup truck by clicking vehicles, then trucks, then its brand. Or the consumer could simply type into a title field of a registration form “pickup truck” or “Ford F150”. Inventory and interface material is discussed in U.S. Pub. 2008/0065514; U.S. Pat. No. 5,989,431; and U.S. Pat. No. 7,774,211, the contents of each of which is herein incorporated by reference in its entirety.

By specifying possessions, the consumer can opt-in to receive matching offers from providers. In some situations, the consumer can reduce the range of merchants from which the consumer would like to receive information, for example, by limiting to certain brands, by specifying certain demographics limitations, or by restricting eligibility based on certain attributes of providers.

In some embodiments, a consumer can elect to respond to information from a provider via systems and methods of the invention. For example, where a provider has made an offer, a consumer can accept via the system or outside of the system. For example, information from a provider can include a web link and consumer can click on the web link to initiate a purchase. The web link can lead the consumer to the storefront website of the provider. The web link is preferably embedded with one or more codes identifying the offer and the offer instance. Based on the embedded codes received, the provider can locate the particular goods or service and start the purchase transaction with the consumer. The embedded codes can represent offers specially targeted or tailored to a particular consumer or community and, thus, may not be available to the general public. The nonpublic feature of offers can allow merchants to tailor offers to focus on certain market segments, without publishing the offers to the general public.

Other than transacting with the provider directly, the consumer can alternatively conduct the purchase transaction within systems of the invention. In the latter situation, the inventory manager can act on behalf of the provider to complete the purchase transaction with the consumer.

A provider can receive a purchase request from the consumer or through the inventory manager. The provider can receive a purchase request in a number of ways. For example, when the consumer clicks through to the website of the provider, information identifying the offer and the offer instance, which can be embedded in URLs, can be transmitted to the provider. In another example, the purchase request can be received through a web service call or through a proxy. The provider can complete the transaction with the consumer or through the inventory manager. The provider can complete the purchase transaction in a number of ways. For example, the purchase can be done completely at the website of the provider. Once the purchase transaction is completed, information about the purchase transaction can be sent to the inventory manager. The provider can rely on the inventory manager to verify that all conditions of the transaction have been met.

One advantage of the invention is the provision for commercial communication that is not spam. A consumer can receive relevant information, subject to limits, criteria, and controls. An aspect of this limitation includes matching provider communication with a consumer based on information associated with the consumer such as a possession registration or a limiting criterion established by the consumer.

Certain features and functions of the invention are supported through logging activity or history. An activity log can be configured to record information relating to activities and interactions of parties, such as consumers and providers. An activity log can further be configured to log timestamps and durations of consumer logons, when and how the profiles, registrations, or inventories of the consumer were updated, the links that the consumer clicks, the time that the consumer spends viewing any web site or information, purchase or transaction activities, etc. Preferably, an activity log records all consumer activities and responses at a substantially detailed level so that the records can support the needs of potential future analysis. The activity logs can then preferably be utilized to provide a wide range of business intelligence, such as consumer habits and offer performances, etc.

A history log can be configured to keep track of matching and other transaction history. Preferably, the history log can aggregate, organize and process information in activity logs, which can be stored in the database. Systems of the invention can provide a flexible mechanism to create alerts and reports, scheduled or ad hoc, to present the information. By providing such aggregated, organized and processed information, the invention can provide important business intelligence to providers, communities, and even consumers. For example, this information can include a complete behavioral record of the consumer. This information can allow the provider to target communication, for example, to send information only to consumers who have purchased goods within the last six months, not to generate offers with discount percentages greater than the discount levels to which the consumer has already responded, or only to send offers to consumers who have clicked through an offer. An activity log can record all activities and responses of consumers including e.g., the timestamps when the consumer logged on, when and how the registrations, profiles, or inventories of the consumer were updated, whether the consumer clicks on a presented communication, whether the consumer eventually makes a purchase, etc. These consumer activities can be used to analyze the matching performance and the purchase behaviors of the consumer, among other things.

Other embodiments are within the scope and spirit of the invention. For example, due to the nature of software, functions described above can be implemented using software, hardware, firmware, hardwiring, or combinations of any of these. Features implementing functions can also be physically located at various positions, including being distributed such that portions of functions are implemented at different physical locations.

While offers are discussed herein, the present description is not limited to offers in a contractual sense. For example, an offer can include advertisements, informational flyers, informational brochures, marketing information, instructional materials, and digital media (e.g., movie or music).

Systems and methods of the invention may generally be implemented through the use of one or more computer. A computer generally includes a processor operably coupled to a memory and configured to send or receive information via input-output device.

One of skill in the art will recognize that a processor may be provided by one or more processors including, for example, one or more of a single core or multi-core processor (e.g., AMD Phenom II X2, Intel Core Duo, AMD Phenom II X4, Intel Core i5, Intel Core i& Extreme Edition 980X, or Intel Xeon E7-2820). In certain embodiments, computer 125 may be a tablet or smart-phone form factor device and processor 281 can be provided by, for example, an ARM-based system-on-a-chip (SoC) processor such as the 1.2 GHz dual-core Exynos SoC processor from Samsung Electronics, (Samsung Town, Seoul, South Korea).

Input-output devices generally includes one or a combination of monitor, keyboard, mouse, data jack (e.g., Ethernet port, modem jack, HDMI port, mini-HDMI port, USB port), Wi-Fi card, touchscreen (e.g., CRT, LCD, LED, AMOLED, Super AMOLED), pointing device, trackpad, microphone, speaker, light (e.g., LED), or light/image projection device.

A memory generally refers to one or more storage devices for storing data or carrying information, e.g., semiconductor, magnetic, magneto-optical disks, or optical disks. Information carriers for a memory suitable for embodying computer program instructions and data include any suitable form of memory that is tangible, non-transitory, non-volatile, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); magneto-optical disks; and optical disks (e.g., CD and DVD disks). The processor and the memory can be supplemented by, or incorporated in, special purpose logic circuitry.

The subject matter described herein can be implemented in a computing system that includes a back-end component (e.g., server computer 521), a middleware component (e.g., an application server), or a front-end component (e.g., consumer computer 501 having a graphical user interface or a web browser through which a user can interact with an implementation of the subject matter described herein), or any combination of such back-end, middleware, and front-end components. The components of the system can be interconnected through network 515 by any form or medium of digital data communication, e.g., a communication network. Examples of communication networks include cell network (e.g., 3G or 4G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, Perl), and it can be deployed in any form, including as a stand-alone program or as a module, component, subroutine, or other unit suitable for use in a computing environment. Systems and methods of the invention can include instructions written in any suitable programming language known in the art, including, without limitation, C, C++, Perl, Java, ActiveX, HTML5, Visual Basic, or JavaScript. In certain embodiments, systems and methods of the invention are implemented through the use of a mobile app. As used herein, mobile app generally refers to a standalone program capable of being installed or run on a smartphone platform such as Android, iOS, Blackberry OS, Windows 8, Windows Mobile, etc.

Functionality of the invention can be implemented by a mobile app or a software application or computer program in other formats included scripts, shell scripts, and functional modules created in development environments.

A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over network 515 (e.g., as packets being sent between a server and a client, for example, through a Network Interface Card, modem, wireless card, or similar).

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user (e.g., a physical arrangement of particles that indicates that a specific Honda Civic is due for a tire rotation on a certain date 18 months in the future). In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file can be invoked manually or automatically by a program or by a save command from software or a write command from a programming language.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A method for managing a lifecycle of a possession comprising:
receiving, by a computer system comprising a memory coupled to a processor, a registration including information containing the identity of a consumer and a possession of the consumer;
storing the registration in a database in the memory;
identifying, by the computer system, a future service event date associated with the possession ; and
sending a notification to a provider that a consumer has a possession with a future event date.

2. The method of claim 1, further comprising sending the notification to a plurality of providers.

3. The method of claim 2, wherein the plurality of providers comprises providers that match criteria established by the consumer.

4. The method of claim 3, wherein the criteria established by the consumer include a geographical location for a candidate provider.

5. The method of claim 2, further comprising:
receiving, from each of the plurality of providers, an offer to provide a service associated with the possession and the event date; and
relaying each of the received offers to the consumer.

6. The method of claim 5, further comprising:
allowing a preferred one of the providers to see information about a competing offer received from a competing provider.

7. The method of claim 1, further comprising obtaining, from the consumer, the consumer's selection of one of the received offers.

8. The method of claim 1, wherein the service event date is at least one year later than the date on which it is identified, and further wherein the notification is sent within two months prior to the event date.

9. The method of claim 1, further comprising storing a plurality of registrations and further wherein the notification includes information about the characteristics of an aggregate group of people who each have a registration for a possession of a certain category.

10. The method of claim 1, further comprising preventing the consumer and the provider from knowing the identity of one another prior to or during any of the steps recited herein.

11. A system for managing a lifecycle of a possession comprising a processor configured to execute code stored in a tangible, non-transitory memory to cause the system to:
receive a registration that includes information containing the identity of a consumer and a possession of the consumer;
store the registration in a database in the memory;
identify a future service event date associated with the possession;
send a notification to a provider with information about the service event date.

12. The system of claim 11, further configured to send the notification to a plurality of providers.

13. The system of claim 12, further configured to:
receive, from each of the providers, an offer to provide a service associated with the service event date;
relay each of the received offers to the consumer; and
obtain, from the consumer, a selection of one of the received offers.

14. The system of claim 13, further configured to share qualifying data about the providers with the consumer.

15. The system of claim 14, where the qualifying data comprises ratings of the providers.

16. A tangible, non-transitory computer readable medium containing programming instructions to facilitate managing a lifecycle of a possession by, when executed by a computer, causing the computer to:
receive a registration including information containing the identity of a consumer and a possession of the consumer;
store the registration in a database;
identify a future event date associated with the possession; and
send a notification to a provider that a consumer has a possession with an event date.

17. The computer readable medium of claim 16, wherein the instructions further cause the computer to:
send the notification to a plurality of providers that match criteria established by the consumer;
receive, from each of the providers, an offer to provide a service associated with the possession and the event date; and
relay the offers to the consumer.

18. The computer readable medium of claim 17, wherein the criteria established by the consumer include one selected from the list consisting of: a geographical location for a candidate provider; a rating value; and a record of previous transactions.

19. The computer readable medium of claim 17, wherein the instructions further cause the computer to obtain a selection from the consumer of one of the received offers.

20. The computer readable medium of claim 17, wherein the possession is one selected from the list of a building, a vehicle, a real estate property, and a fixture.

21. A method of managing a lifecycle of a possession, the method comprising:
storing, in a tangible and non-transitory memory of a computer comprising a processor operably coupled to the memory, an inventory of an owner, the inventory comprising a registration including information about a possession;
identifying, using the computer, an event date associated with the possession;
receiving a notice of a transfer from the owner; and
transferring the registration into an inventory of a buyer.

22. The method of claim 21, further comprising creating, responsive to a request received via the Internet from the buyer, an account for the buyer and the inventory of the buyer.

23. The method of claim 21, further comprising denying access to the registration to anyone after receiving the notice of transfer and prior to transferring the registration.

24. The method of claim 21, wherein the registration includes information obtained, in response to input from the owner, through the Internet from a third-party vendor.

25. The method of claim 21, wherein event date is automatically generated by the processor in response to the information about the possession.

26. The method of claim 21, further comprising:
notifying, within two months prior to the event date, the owner of the event date; and
treating the buyer as the owner after transferring the registration.

27. The method of claim 21, wherein the registration comprises historical information relating to past service events of the possession.

28. The method of claim 21, wherein the registration comprises one selected from the list consisting of: architectural drawings, device specifications, make and model of parts, identity of a builder, identity of a service-person, identity of an architect, and device serial number.

29. The method of claim 21, wherein the owner is the entity that created the possession and the buyer is the first purchaser of the possession.

30. The method of claim 21, wherein the registration transfer is repeated for successive owners of the possession.

31. A system for managing a lifecycle of a possession, the system comprising a computer including a tangible, non-transitory memory coupled to a processor and configured to, by means of the processor:
store, in the memory, an inventory of an owner comprising a registration including information about a possession;
identify an event date associated with the possession;
receive a notice of a transfer from the owner; and
transfer the registration into an inventory of a buyer.

32. The system of claim 31, further configured to create, responsive to a request received via the Internet from the buyer, an account for the buyer and the inventory of the buyer.

33. The system of claim 31, further configured to deny access to the record to anyone after receiving the notice of transfer and prior to transferring the registration.

34. The system of claim 31, wherein the registration includes information obtained, in response to input from the owner, through the Internet from a third-party vendor.

35. A tangible, non-transitory computer readable medium containing programming instructions to facilitate managing a lifecycle of a possession by causing the computer to:
store, in a database, an inventory of an owner comprising a registration including information about a possession;
identify an event date associated with the possession; and
transfer the registration into an inventory of a buyer.

36. The computer readable medium of claim 35, wherein the instructions further cause the computer to receive a notice of a transfer from the owner.

37. The computer readable medium of claim 35, wherein the instructions further cause the computer to:
notify, less than three months prior to the event date, the owner of the event date; and
treat the buyer as the owner after transferring the registration.

38. The computer readable medium of claim 35, wherein the instructions further cause the computer to:
notify the buyer of a plurality of scheduled service events associated with the possession; and
provide the buyer with a service record of the possession including data generated prior to the transfer.

39. The computer readable medium of claim 35, wherein the instructions further cause the computer to:
obtain information from a third-party vendor in response to input from the owner and through the Internet; and
store the information in the registration.

40. The method of claim 1, wherein the future service event date is associated with a follow-on item related to the possession.

41. The method of claim 41, wherein the follow-on item comprises one selected from the list consisting of an accessory, a consumable, a replacement, an update, and a download.
